(19) United States
(12) Patent Application Publication
(10) Pub. No.: US 2022/0201777 A1
(43) Pub. Date: Jun. 23, 2022

(54) Enhanced Handover of Nodes in Integrated Access Backhaul (IAB) Networks - Control Plane (CP) Handling

(71) Applicant: Telefonaktiebolaget LM Ericsson (publ), Stockholm (SE)

(72) Inventors: Oumer Teyeb, Solna (SE); Gunnar Mildh, Sollentuna (SE); Matteo Fiorani, Solna (SE); Lian Araujo, Solna (SE)

(21) Appl. No.: 17/267,533

(22) PCT Filed: Aug. 20, 2019
(86) PCT No.: PCT/IB2019/057007

§ 371 Date: Feb. 10, 2021

Related U.S. Application Data
(60) Provisional application No. 62/722,056, filed on Aug. 23, 2018.

(51) Int. Cl. H04W 76/12; H04W 24/10; H04L 5/00

(52) U.S. Cl. CPC H04W 76/12; H04W 88/14; H04L 5/0053; H04W 24/10

(57) ABSTRACT

Embodiments include methods performed by a centralized unit, CU, in a radio access network (RAN) that includes a first node. Embodiments include determining that a control plane (CP) connection between the CU and the first node should be moved from a source path in the RAN to a target path, which includes at least one radio access node not in the source path. Embodiments also include, based on determining that the CP connection should be moved, sending to the first node a message including transport network layer (TNL) association(s) related to the CP connection. The message is sent before the first node relocates to the target path. Embodiments also include, after the first node has relocated to the target path, establishing a transport layer protocol connection with the first node over the target path based on the TNL association(s).

### TECHNICAL FIELD

The present application relates generally to the field of wireless communication networks, and more specifically to integrated access backhaul (IAB) networks in which the available wireless communication resources are shared between user access to the network and backhaul of user traffic within the network (e.g., to/from a core network).

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objectives, features and advantages of the disclosed embodiments will be apparent from the following description.

FIG. 1 illustrates a high-level view of the 5G network architecture, consisting of a Next Generation RAN (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMF) in the 5GC 198 via respective NG-C interfaces. Similarly, gNBs 100, 150 can be connected to one or more User Plane Functions (UPFs) in 5GC 198 via respective NG-U interfaces.

In addition, the gNBs can be connected to each other via one or more Xn interfaces, such as Xn interface 140 between gNBs 100 and 150. The radio technology for the NG-RAN is often referred to as “New Radio” (NR). With respect to the NR interface to UEs, each of the gNBs can support frequency division duplexing (FDD), time division duplexing (TDD), or a combination thereof.

Although not shown, in some deployments 5GC 298 can be replaced by an Evolved Packet Core (EPC), which conventionally has been used together with a Long-Term Evolution (LTE) Evolved UMTS RAN (E-UTRAN). In such deployments, gNBs 200, 250 (referred to as “en-gNBs” in this scenario) may be connected to the EPC via the S1-U interface and to each other (and/or to other en-gNBs) via the X2-U interface.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB is connected to all 5GC nodes within an “AMF Region” which is defined in 3GPP TS 23.501 (version 15.2.0). If security protection for CP and UP data on TNL of NG-RAN interfaces is supported, NDS/IP (3GPP TS 33.401 (version 15.4.0)) shall be applied.

The NG-RAN logical nodes shown in FIG. 1 (and described in 3GPP TS 38.401 (version 15.2.0) and 3GPP TR 38.801 (version 14.0.0)) include a Central Unit (CU or gNB-CU) and one or more Distributed Units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. A DU (e.g., gNB-DUs 120, 130) is a decentralized logical node that hosts lower layer protocols and can include, depending on the functional split option, various subsets of the gNB functions. As such, each of the CUs and DUs can include various circuitry needed to perform their respective functions, including processing circuitry, transceiver circuitry (e.g., for communication), and power supply circuitry. Moreover, the terms “central unit” and “centralized unit” are used interchangeably herein, as are the terms “distributed unit” and “decentralized unit.”

A gNB-CU connects to one or more gNB-DUs over respective F1 logical interfaces, such as interfaces 122 and 132 shown in FIG. 1. However, a gNB-DU can be connected to only a single gNB-CU. The gNB-CU and connected gNB-DU(s) are only visible to other gNBs and the 5GC as a gNB. In other words, the F1 interface is not visible beyond gNB-CU.

Furthermore, the F1 interface between the gNB-CU and gNB-DU is specified and/or based on the following general principles:
F1 is an open interface;
F1 supports the exchange of signalling information between respective endpoints, as well as data transmission to the respective endpoints;
from a logical standpoint, F1 is a point-to-point interface between the endpoints (even in the absence of a physical direct connection between the endpoints);
F1 supports control plane and user plane separation into respective F1-AP protocol and F1-U protocol (also referred to as NR User Plane Protocol), such that a gNB-CU may also be separated in CP and UP;
F1 separates Radio Network Layer (RNL) and Transport Network Layer (TNL);
F1 enables exchange of user-equipment (UE) associated information and non-UE associated information;
F1 is defined to be future proof with respect to new requirements, services, and functions;
A gNB terminates X2, Xn, NG and S1-U interfaces and, for the F1 interface between DU and CU, utilizes the F1-AP protocol that is defined in 3GPP TS 38.473 (version 15.2.1).

In addition, the F1-U protocol is used to convey control information related to the user data flow management of data radio bearers, as defined in 3GPP TS 38.425 (version 15.2.0). The F1-U protocol data is conveyed by the GTP-U protocol, specifically, by the “RAN Container” GTP-U extension header as defined in 3GPP TS 29.281 (version 15.3.0). In other words, the GTP-U protocol over user datagram protocol (UDP) over IP carries data streams on the F1 interface. A GTP-U “tunnel” between two nodes is identified in each node by tunnel endpoint identifier (TEID), an IP address, and a UDP port number. A GTP-U tunnel is necessary to enable forwarding packets between GTP-U entities.

In addition, a CU can host protocols such as radio resource control (RRC) protocol and packet data convergence protocol (PDCP), while a DU can host protocols such as RLC, MAC and PHY. Other variants of protocol distributions between CU and DU can exist, however, such as hosting RRC, PDCP, and part of RLC protocol in the CU (e.g., Automatic Retransmission Request (ARQ) function), while hosting physical layer (PHY), medium access control (MAC) protocol, and the remaining parts of RLC in the DU. In some embodiments, a CU can host RRC and PDCP, where PDCP is assumed to handle both UP traffic and CP traffic. Nevertheless, other embodiments may utilize other protocol splits that by hosting certain protocols in the CU and certain others in the DU. Exemplary embodiments can also locate centralized control plane protocols (e.g., PDCP-C and RRC) in a different CU with respect to the centralized user plane protocols (e.g., PDCP-U).

It has also been agreed in 3GPP RAN3 Working Group (WG) to support a separation of the gNB-CU into a CU-CP function (including RRC and PDCP for signaling radio bearers) and CU-UP function (including PDCP for user plane), with the E1 open interface between (see 3GPP TS 38.463 (version 15.0.0)). The CU-CP and CU-UP parts communicate with each other using the E1-AP protocol over the E1 interface. The CU-CP/UP separation is illustrated in FIG. 2. Three deployment scenarios for the split gNB architecture shown in FIG. 2 are defined in 3GPP TR 38.806 (version 15.0.0):
Scenario 1: CU-CP and CU-UP centralized;
Scenario 2: CU-CP distributed and CU-UP centralized;
Scenario 3: CU-CP centralized and CU-UP distributed.

Densification via the deployment of more and more base stations (e.g., macro or micro base stations) is one of the mechanisms that can be employed to satisfy the increasing demand for bandwidth and/or capacity in mobile networks, which is mainly driven by the increasing use of video streaming services. Due to the availability of more spectrum in the millimeter wave (mmw) band, deploying small cells that operate in this band is an attractive deployment option for these purposes. However, the normal approach of connecting the small cells to the operator's backhaul network with optical fiber can end up being very expensive and impractical. Employing wireless links for connecting the small cells to the operator's network is a cheaper and more practical alternative. One such approach is an integrated access backhaul (IAB) network where the operator can utilize part of the radio resources for the backhaul link.

IAB was studied earlier in 3GPP in the scope of Long Term Evolution (LTE) Rel-10. In that work, an architecture was adopted where a Relay Node (RN) has the functionality of an LTE eNB and UE modem. The RN is connected to a donor eNB which has a S1/X2 proxy functionality hiding the RN from the rest of the network. That architecture enabled the Donor eNB to also be aware of the UEs behind the RN and hide any UE mobility between Donor eNB and Relay Node on the same Donor eNB from the CN. During the Rel-10 study, other architectures were also considered including, e.g., where the RNs are more transparent to the Donor gNB and allocated a separate stand-alone P/S-GW node.

For 5G/NR, similar options utilizing IAB can also be considered. One difference compared to LTE is the gNB-CU/DU split described above, which separates time critical RLC/MAC/PHY protocols from less time critical RRC/PDCP protocols. It is anticipated that a similar split could also be applied for the IAB case. Other IAB-related differences anticipated in NR as compared to LTE are the support of multiple hops and the support of redundant paths.

FIG. 3 shows a reference diagram for an IAB network in standalone mode, as further explained in 3GPP TR 38.874 (version 0.2.1). The IAB network shown in FIG. 3 includes one IAB-donor 340 and multiple IAB-nodes 311-315, all of which can be part of a radio access network (RAN) such as an NG-RAN. IAB donor 340 includes DUs 321, 322 connected to a CU, which is represented by functions CU-CP 331 and CU-UP 332. IAB donor 340 can communicate with core network (CN) 350 via the CU functionality shown.

Each of the IAB nodes 311-315 connects to the IAB-donor via one or more wireless backhaul links (also referred to herein as “hops”). More specifically, the Mobile-Termination (MT) function of each IAB -node 311-315 terminates the radio interface layers of the wireless backhaul towards a corresponding “upstream” (or “northbound”) DU function. This MT functionality is similar to functionality that enables UEs to access the IAB network and, in fact, has been specified by 3GPP as part of the Mobile Equipment (ME).

In the context of FIG. 3, upstream DUs can include either DU 321 or 322 of IAB donor 340 and, in some cases, a DU function of an intermediate IAB node that is “downstream” (or “southbound”) from IAB donor 340. As a more specific example, IAB-node 314 is downstream from IAB-node 312 and DU 321, IAB-node 312 is upstream from IAB-node 314 but downstream from DU 321, and DU 321 is upstream from IAB-nodes 312 and 314. The DU functionality of IAB nodes 311-315 also terminates the radio interface layers toward UEs (e.g., for network access via the DU) and other downstream IAB nodes.

As shown in FIG. 3, IAB-donor 340 can be treated as a single logical node that comprises a set of functions such as gNB-DUs 321-322, gNB-CU-CP 331, gNB-CU-UP 332, and possibly other functions. In some deployments, the IAB-donor can be split according to these functions, which can all be either co-located or non-co-located as allowed by the 3GPP NG-RAN architecture. Also, some of the functions presently associated with the IAB-donor can be moved outside of the IAB-donor if such functions do not perform IAB-specific tasks.

Each IAB-node DU connects to the IAB-donor CU using a modified form of F1, which is referred to as F1*. The user-plane portion of F1* (referred to as “F1*-U”) runs over RLC channels on the wireless backhaul between the MT on the serving IAB-node and the DU on the IAB donor.

In addition, an adaptation layer is included to hold routing information, thereby enabling hop-by-hop forwarding by IAB nodes. In some sense, the adaptation layer replaces the IP functionality of the standard F1 stack. F1*-U may carry a GTP-U header for the end-to-end association between CU and DU (e.g., IAB-node DU). In a further enhancement, information carried inside the GTP-U header can be included into the adaption layer. Furthermore, in various alternatives, the adaptation layer for IAB can be inserted either below or above the RLC layer. Optimizations to RLC layer itself are also possible, such as applying ARQ only on the end-to-end connection (i.e., between the donor DU and the IAB node MT) rather than hop-by-hop along access and backhaul links (e.g., between downstream IAB node MT and upstream IAB node DU).

Topology adaptation can be used to change and/or modify an IAB network topology to insure that an IAB node can continue to operate (e.g., providing coverage and end user service continuity) even if the IAB node's current active backhaul path is degraded or lost. Furthermore, it is also desirable to minimize service disruption and packet loss during topology adaptation. IAB topology adaptation can be triggered by integration of a IAB node to the topology, detachment of an IAB node from the topology, detection of backhaul link overload, deterioration of backhaul link quality or link failure, or other events.

Currently, there exists various issues and/or problems with respect to relocating GTP-U tunnels between nodes in an IAB network during topology adaptation. Moreover, there are no established solutions to address such issues and/or problems.

### SUMMARY

Accordingly, exemplary embodiments of the present disclosure address these and other difficulties in configuration and/or management of a 5G network comprising IAB nodes, thereby facilitating the otherwise-advantageous deployment of IAB solutions.

Some exemplary embodiments include methods (e.g., procedures) performed by a centralized unit (CU) in a radio access network (RAN) comprising a first radio access node and a plurality of further radio access nodes. In some embodiments, the RAN can be an integrated access backhaul network (IAB) and at least a portion of the radio access nodes can be IAB nodes.

The exemplary methods can include determining that a control plane (CP) connection between a first radio access node and the CU should be moved from a source path in the RAN to a target path in the RAN. The target path can include at least one radio access node not included in the source path. For example, the source path can include a first subset of the further radio access nodes and a source distributed unit (DU) connected to the CU, while the target path can include a second subset of the further radio access nodes and a target DU connected to the CU. In some embodiments, the first radio access node can include a first mobile terminal and a first DU, and the CP connection can be an F1-C connection between the CU and the first DU.

The exemplary methods can also include, based on determining that the CP connection between the CU and the first radio access node should be moved, sending to the first radio access node a message including one or more transport network layer (TNL) associations related to the CP connection. This message can be sent (e.g., via the source path) before the first radio access node has relocated to the target path. In some embodiments, each TNL association can include a tunnel endpoint identifier (TEID) and an Internet Protocol (IP) address. In some embodiments, the one or more TNL associations in the message can include one or more first TNL associations, related to the source path, to be removed; and one or more second TNL associations, related to the target path, to be added.

The exemplary methods can also include establishing a transport layer protocol connection with the first radio access node over the target path based on the TNL associations. This operation can be performed after the first radio access node has relocated to the target path. In some embodiments, the transport layer protocol connection can be a Stream Control Transmission Protocol (SCTP) association. Establishing the transport layer protocol connection can performed in various ways, as described herein.

Other exemplary embodiments include methods (e.g., procedures) performed by a first radio access node in a RAN that includes a CU and a plurality of further radio access nodes. In some embodiments, the RAN can be an IAB network and the first radio access node can be an IAB node.

The exemplary method can include receiving, via a control plane (CP) connection with the CU, a message including one or more transport network layer (TNL) associations related to the CP connection. The message can be received via a source path in the RAN. The exemplary method can also include subsequently relocating to a target path in the RAN.

The target path can include at least one radio access node not included in the source path. For example, the source path can include a first subset of the further radio access nodes and a source distributed unit (DU) connected to the CU, while the target path can include a second subset of the further radio access nodes and a target DU connected to the CU.

In some embodiments, the first radio access node can include a first mobile terminal and a first DU, and the CP connection can be an F1-C connection between the CU and the first DU. In some embodiments, each TNL association can include a tunnel endpoint identifier (TEID) and an Internet Protocol (IP) address. In some embodiments, the one or more TNL associations in the message can include one or more first TNL associations, related to the source path, to be removed; and one or more second TNL associations, related to the target path, to be added.

The exemplary method can also include establishing a transport layer protocol connection with the CU over the target path based on the received TNL associations. The transport layer protocol connection can be established after first radio access node relocates to the target path. In some embodiments, the transport layer protocol connection can be a SCTP association. Establishing the transport layer protocol connection can performed in various ways, as described herein.

Other exemplary embodiments include CUs, first radio access nodes (e.g., base stations), and combinations thereof, configured to perform operations of the exemplary methods described herein. Other exemplary include non-transitory, computer-readable media storing computer-executable instructions that, when executed by processing circuitry of a CU or a first radio access node, configure the CU or the first radio access node to perform operations of the exemplary methods described herein.

These and other objects, features, and advantages of the present disclosure will become apparent upon reading the following Detailed Description in view of the Drawings briefly described below.

### BRIEF DESCRIPTION OF THE DRAWINGS

FIG. 1 illustrates a high-level view of the 5G network architecture, including a Next Generation radio access network (NG-RAN) and a 5G core (5GC) network.

FIG. 2 illustrates interfaces within an NG-RAN node (e.g., gNB) that support control plane (CP) and user plane (UP) functionality.

FIG. 3 shows a reference diagram for an integrated access backhaul (IAB) network in standalone mode.

FIGS. 4-5 show block diagrams of two different IAB reference architectures, i.e., architectures “1a” and “1b” as specified in 3GPP TR 38.874 (version 0.2.1).

FIGS. 6A-E illustrate exemplary user-plane (UP) protocol stack arrangements for architecture “1a,” with each arrangement corresponding to a different placement of an adaptation layer.

FIG. 7 illustrates an exemplary UP protocol stack arrangement for architecture “1b.”

FIGS. 8A-C show exemplary user equipment (UE) radio resource control (RRC), mobile terminal (MT) RRC, and distributed unit (DU) F1-AP protocol stacks, respectively, for a first alternative for architecture “1a” (also referred to as “alternative 1”).

FIGS. 9A-C show exemplary UE RRC, MT RRC, and DU F1-AP protocol stacks, respectively, for a second alternative for architecture “1a” (also referred to as “alternative 2”).

FIGS. 10A-C show exemplary UE RRC, MT RRC, and DU F1-AP protocol stacks, respectively, for a third alternative for architecture “1a” (also referred to as “alternative 3”).

FIGS. 11A-C show exemplary UE RRC, MT RRC, and DU F1-AP protocol stacks, respectively, for a fourth alternative for architecture “1a” (also referred to as “alternative 4”).

FIGS. 12A-B show two exemplary topologies for IAB Topology Adaptation.

FIGS. 13A-B illustrate a spanning tree (ST) topology before and after a particular node changes its attachment point (“migrates”) from a source parent node to a target parent node, according to various exemplary embodiments of the present disclosure.

FIG. 14 shows a signal flow diagram of a procedure corresponding to the ST topology adaptation illustrated in FIG. 13.

FIG. 15A-B show an exemplary ST topology adaptation where the migrating IAB node has a descendent IAB node, according to various exemplary embodiments of the present disclosure.

FIG. 16 shows a signal flow diagram for an exemplary F1 setup and cell activation procedure, according to various exemplary embodiments of the present disclosure.

FIGS. 17-18 show a signal flow diagram for successful operation of an exemplary gNB-DU Configuration Update procedure and message structures used therein, according to various exemplary embodiments of the present disclosure.

FIGS. 19-20 show a signal flow diagram for successful operation of an exemplary gNB-CU Configuration Update procedure and message structures used therein, according to various exemplary embodiments of the present disclosure.

FIG. 21 shows a signal flow diagram for an exemplary procedure for managing multiple TNL addresses (TNLAs) between a gNB-DU and a gNB-CU, according to various exemplary embodiments of the present disclosure.

FIG. 22 shows an exemplary method (e.g., procedure) performed by a centralized unit (CU) in a radio access network (RAN), according to various exemplary embodiments of the present disclosure.

FIG. 23 shows an exemplary method (e.g., procedure) performed by a first node in a radio access network (RAN), according to various exemplary embodiments of the present disclosure.

FIG. 24 illustrates an exemplary embodiment of a wireless network, in accordance with various aspects described herein.

FIG. 25 illustrates an exemplary embodiment of a UE, in accordance with various aspects described herein.

FIG. 26 is a block diagram illustrating an exemplary virtualization environment usable for implementation of various embodiments of network nodes described herein.

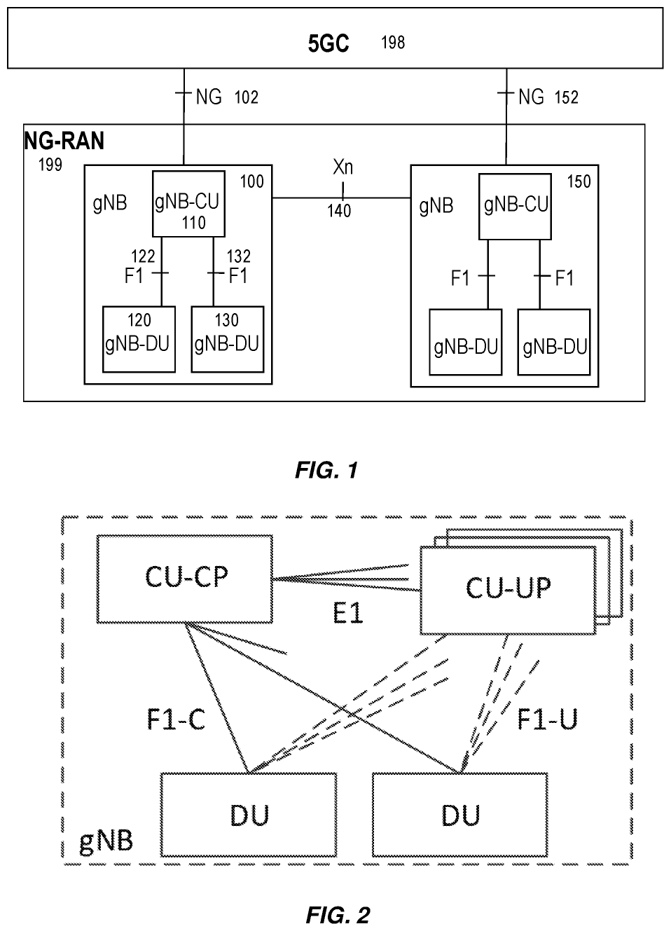

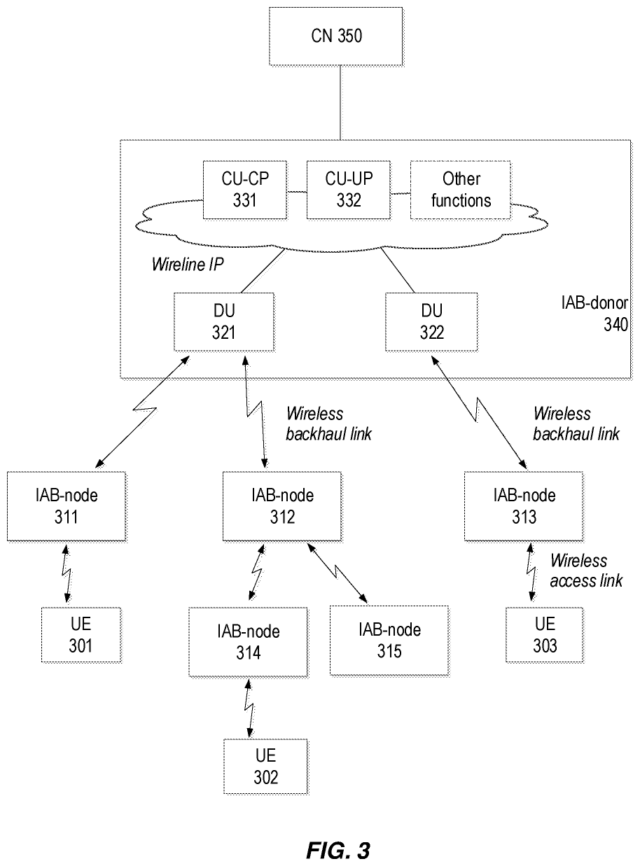

### DETAILED DESCRIPTION

Exemplary embodiments briefly summarized above will now be described more fully with reference to the accompanying drawings. These descriptions are provided by way of example to explain the subject matter to those skilled in the art, and should not be construed as limiting the scope of the subject matter to only the embodiments described herein. More specifically, examples are provided below that illustrate the operation of various embodiments according to the advantages discussed above. Furthermore, the following terms are used throughout the description given below:
Radio Node: As used herein, a “radio node” can be either a “radio access node” or a “wireless device.”
Radio Access Node: As used herein, a a “radio access node” (or alternately “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), a high-power or macro base station, a low-power base station (e.g., a micro base station, a pico base station, a home eNB, or the like), an integrated access backhaul (IAB) node, and a relay node.
Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Unless otherwise noted, the term “wireless device” is used interchangeably herein with “user equipment” (or “UE” for short). Some examples of a wireless device include, but are not limited to, a UE in a 3GPP network and a Machine Type Communication (MTC) device. Communicating wirelessly can involve transmitting and/or receiving wireless signals using electromagnetic waves, radio waves, infrared waves, and/or other types of signals suitable for conveying information through air.
Network Node: As used herein, a “network node” is any node that is either part of the radio access network or the core network of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a wireless device or a network node may be distributed over a plurality of wireless devices and/or network nodes. Furthermore, although the term “cell” is used herein, it should be understood that (particularly with respect to 5G NR) beams may be used instead of cells and, as such, concepts described herein apply equally to both cells and beams.

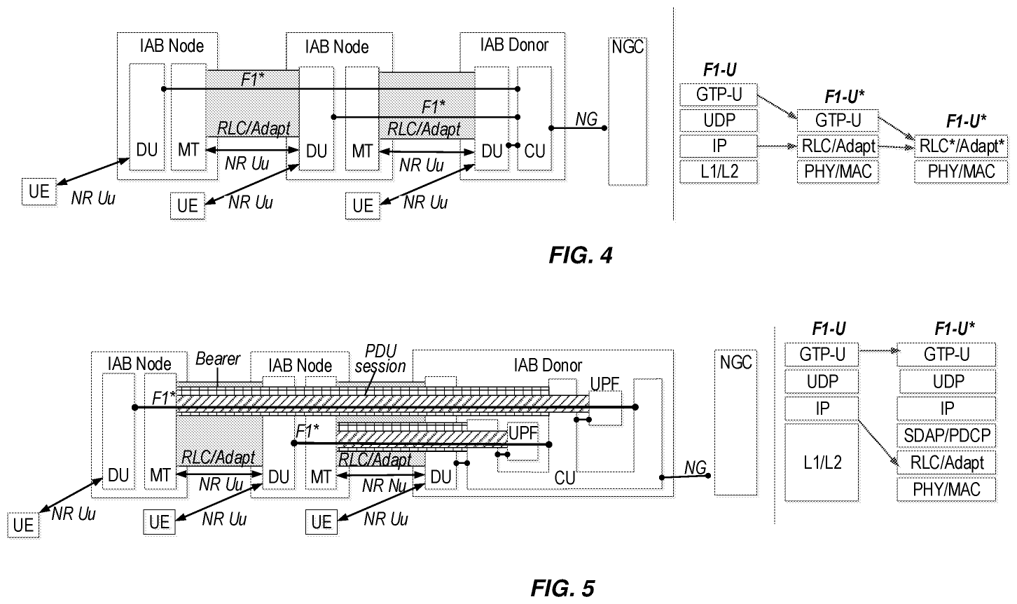

3GPP TR 38.874 (version 0.2.1) specifies several reference architectures for supporting user plane traffic over IAB nodes, including IAB Donor nodes. FIG. 4 shows a block diagram of reference architecture “1a”, which leverages the CU/DU split architecture in a two-hop chain of IAB nodes underneath an IAB-donor.

In this architecture, each IAB node holds a DU and an MT. Via the MT, the IAB-node connects to an upstream IAB-node or the IAB-donor. Via the DU, the IAB-node establishes RLC-channels to UEs and to MTs of downstream IAB-nodes. For MTs, this RLC-channel may refer to a modified RLC*. Whether an IAB node can connect to more than one upstream IAB-node or IAB -donor is for further study.

The IAB Donor also includes a DU to support UEs and MTs of downstream IAB nodes. The IAB-donor holds a CU for the DUs of all IAB-nodes and for its own DU. It is for further study (FFS) in 3GPP whether different CUs can serve the DUs of the IAB-nodes. Each DU on an IAB -node connects to the CU in the IAB-donor using a modified form of F1, which is referred to as F1*. F1*-U runs over RLC channels on the wireless backhaul between the MT on the serving IAB-node and the DU on the donor. F1*-U transport between MT and DU on the serving IAB-node as well as between DU and CU on the donor is for further study. An adaptation layer is added, which holds routing information, enabling hop-by-hop forwarding. It replaces the IP functionality of the standard F1-stack. F1*-U may carry a GTP-U header for the end-to-end association between CU and DU. In a further enhancement, information carried inside the GTP-U header may be included into the adaption layer. Further, optimizations to RLC may be considered such as applying ARQ only on the end-to-end connection opposed to hop-by-hop.

The right side of FIG. 4 shows two examples of such F1*-U protocol stacks. In this figure, enhancements of RLC are referred to as RLC*. The MT of each IAB-node further sustains NAS connectivity to the NGC, e.g., for authentication of the IAB-node. It further sustains a PDU-session via the NGC, e.g., to provide the IAB-node with connectivity to the OAM. Details of F1*, the adaptation layer, RLC*, hop-by-hop forwarding, and transport of F1-AP are for further study (FFS) in 3GPP. Protocol translation between F1* and F1 in case the IAB-donor is split is also FFS.

FIG. 5 shows a block diagram of an IAB reference architecture “1b”, which also leverages the CU/DU split architecture in a two-hop chain of IAB nodes underneath an IAB-donor. The IAB-donor holds one logical CU. In this architecture, each IAB-node and the IAB-donor hold the same functions as in architecture la. Also, as in architecture 1a, every backhaul link establishes an RLC-channel, and an adaptation layer is inserted to enable hop-by-hop forwarding of F1*.

In architecture 1b, however, the MT on each IAB-node establishes a PDU-session with a user plane function (UPF) residing on the donor. The MT's PDU-session carries F1* for the collocated DU. In this manner, the PDU-session provides a point-to-point link between CU and DU. On intermediate hops, the PDCP-PDUs of F1* are forwarded via an adaptation layer in the same manner as described for architecture 1a. The right side of FIG. 5 shows an example of the F1*-U protocol stack.

The following discussion describes various UP aspects for architecture group 1 including placement of an adaptation layer, functions supported by the adaptation layer, support of multi-hop RLC, impacts on scheduler and QoS. The study will analyse the described architecture options to identify trade-offs between these various aspects with the goal to recommend a single architecture for this group.

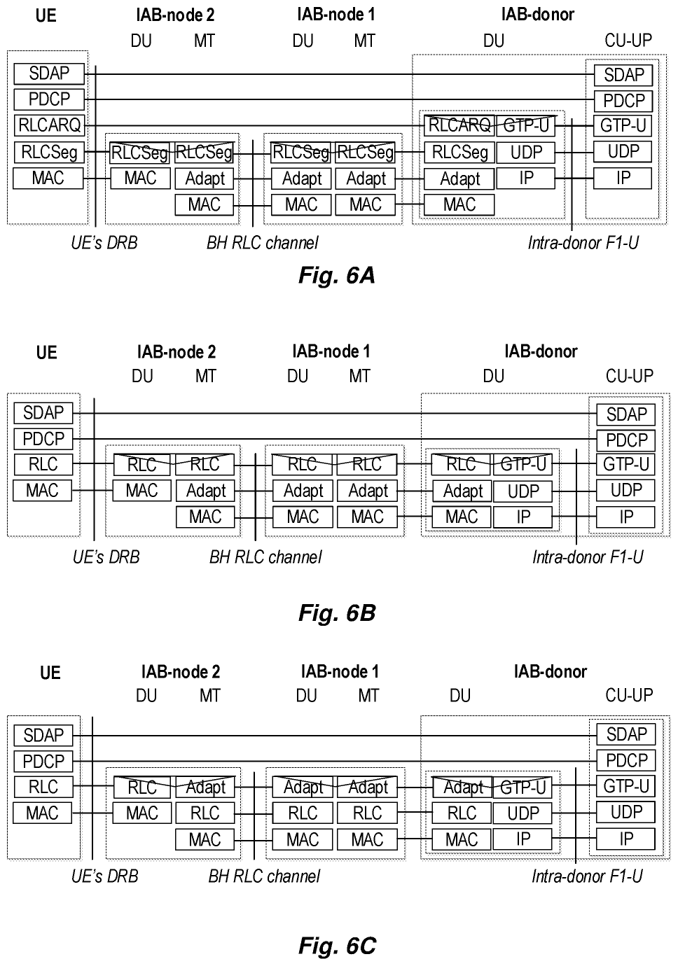

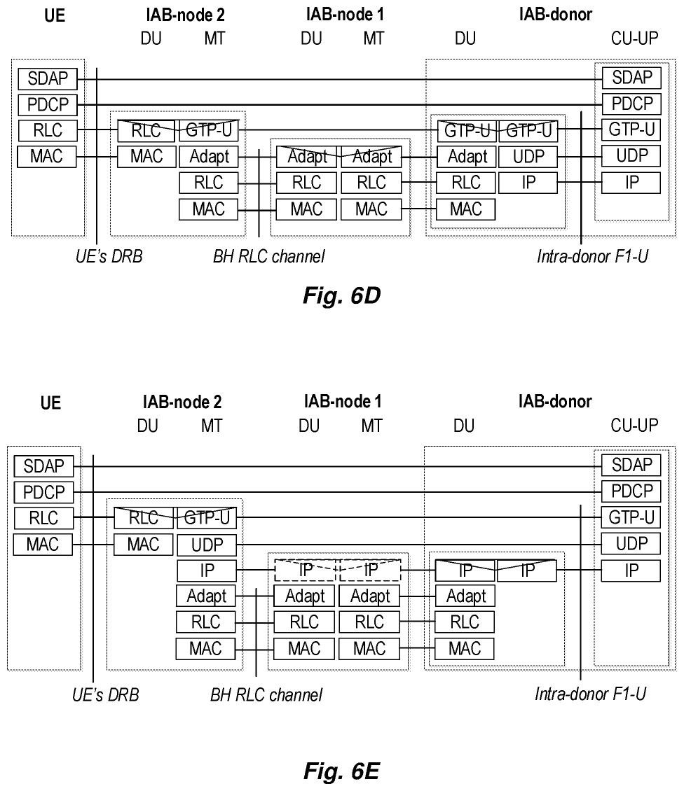

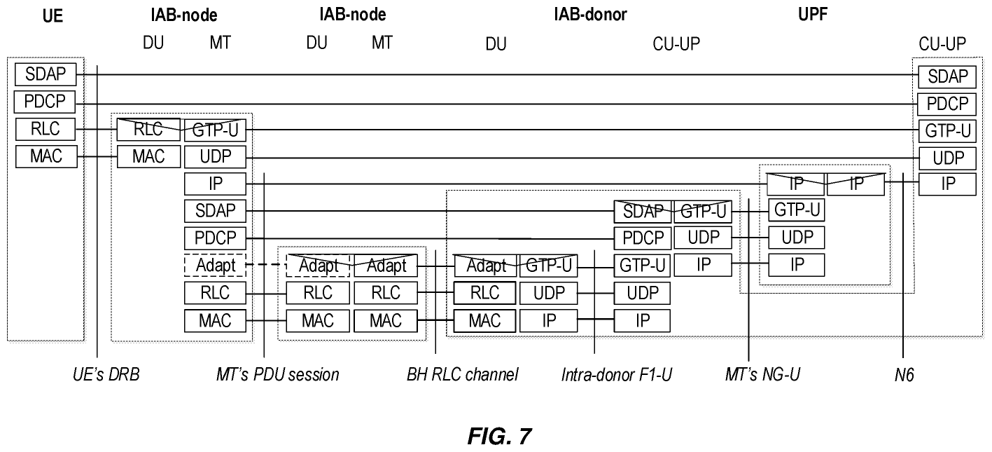

The following discussion refers to FIGS. 6-7, which show various protocol stack examples for UE Access using L2-relaying with adaptation according to architectures la and lb, respectively. More specifically, FIGS. 6A-E illustrate exemplary UP protocol arrangements for architecture 1a, with each arrangement corresponding to a different placement of the adaptation layer. Furthermore, each arrangement shows protocol stacks for UE, the UE's access IAB node, an intermediate IAB node, and the IAB donor DU/CU. FIG. 7 illustrates an exemplary user-plane protocol stack arrangement for architecture 1b, also including protocol stacks for UE, the UE's access IAB node, and intermediate IAB node, and the IAB donor DU/CU. It is important to note that FIGS. 6-7 only show exemplary protocol stacks and do not preclude other possibilities.

As briefly mentioned above, the F1-U protocol (also referred to as NR User Plane Protocol) is used to convey control information related to the user data flow management of data radio bearers, as defined in 3GPP TS 38.425 (version 15.2.0). The F1-U protocol data is conveyed by the GTP-U protocol, specifically, by the “RAN Container” GTP-U extension header as defined in 3GPP TS 29.281 (version 15.3.0). In other words, the GTP-U protocol over user datagram protocol (UDP) over IP carries data streams on the F1 interface. A GTP-U “tunnel” between two nodes is identified in each node by tunnel endpoint identifier (TEID), an IP address, and a UDP port number. A GTP-U tunnel is necessary to enable forwarding packets between GTP-U entities.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In NG-Flex configuration, each gNB is connected to all 5GC nodes within a pool area. The pool area is defined in 3GPP TS 23.501 (version 15.2.0). If security protection for control plane and user plane data on TNL of NG-RAN interfaces has to be supported, NDS/IP (3GPP TS 33.401 (version 15.4.0)) shall be applied.

GTP-U over UDP over IP serves as the TNL for data (i.e., UP) streams on the F1 interface. The transport bearer is identified by the GTP-U tunnel endpoint ID (TEID) and the IP address, i.e., (source TEID, destination TEID, source IP address, destination IP address). The F1-U protocol uses the services of the TNL in order to allow flow control of user data packets transferred from the node hosting NR PDCP (CU-UP in the case of CU-DU split) to the corresponding node (DU). The followings services provided by F1-U are defined in 3GPP TS 38.425 (version 15.2.0):
Provision of NR user plane specific sequence number information for user data transferred from the node hosting NR PDCP to the corresponding node for a specific data radio bearer.
Information of successful in sequence delivery of NR PDCP PDUs to the UE from the corresponding node for user data associated with a specific data radio bearer.
Information of NR PDCP PDUs that were not delivered to the UE or the lower layers.
Information of NR PDCP PDUs transmitted to the lower layers for user data associated with a specific data radio bearer.
Information of downlink NR PDCP PDUs to be discarded for user data associated with a specific data radio bearer.
Information of the currently desired buffer size at the corresponding node for transmitting to the UE user data associated with a specific data radio bearer.
Information of the currently minimum desired buffer size at the corresponding node for transmitting to the UE user data associated with all data radio bearers configured for the UE at the corresponding node.
Information of successful in sequence delivery of NR PDCP PDUs to the UE from the corresponding node for retransmission user data associated with a specific data radio bearer.
Information of NR PDCP PDUs transmitted to the lower layers for retransmission user data associated with a specific data radio bearer.
Information of the specific events at the corresponding node (e.g. radio link outage, radio link resume).

The UE establishes RLC channels to the DU on the UE's access IAB node in compliance with 3GPP TS 38.300 (version 15.2.0). Each of these RLC channels is extended via a potentially modified form of F1-U, referred to as F1*-U, between the UE's access DU and the IAB donor. The information embedded in F1*-U is carried over RLC channels across the backhaul links. Transport of F1*-U over the wireless backhaul is enabled by an adaptation layer, which is integrated with the RLC channel. Within the IAB-donor (referred to as fronthaul), the baseline is to use native F1-U stack. The IAB-donor DU relays between F1-U on the fronthaul and F1*-U on the wireless backhaul.

In architecture 1a, information carried on the adaptation layer supports the following functions:
Identification of the UE-bearer for the PDU,
Routing across the wireless backhaul topology,
QoS-enforcement by the scheduler on DL and UL on the wireless backhaul link,
Mapping of UE user-plane PDUs to backhaul RLC channels,
Others.
   Similarly, in architecture 1b, information carried on the adaptation layer supports the following functions:
Routing across the wireless backhaul topology,
QoS-enforcement by the scheduler on DL and UL on the wireless backhaul link,
Mapping of UE user-plane PDUs to backhaul RLC channels
Others.
   Information to be carried on the adaptation layer header may include:
UE-bearer-specific Id
UE-specific Id
Route Id, IAB-node or IAB-donor address
QoS information
Potentially other information

IAB nodes can use the identifiers carried via the adaptation layer to ensure required QoS treatment and to decide which hop a packet should be sent to. Although details of the information carried in the adaptation layer are FFS in 3GPP, a brief overview is provided below on how the above information may be used to this end, if included in the final design of the adaptation layer.

The UE-bearer-specific ID may be used by the IAB-node and the IAB-donor to identify a PDU's UE-bearer. A UE's access IAB node would then map adaptation-layer information (e.g. UE-specific ID, UE-bearer specific ID) into the corresponding cell radio network temporary identifier (C-RNTI) and logical channel ID (LCID). The IAB Donor DU may also need to map adaptation-layer information into the F1-U GTP-U TEID used between Donor DU and Donor CU.

UE-bearer-specific Id, UE-specific Id, Route Id, or IAB-node/IAB-donor address may be used (e.g., in combination or individually) to route the PDU across the wireless backhaul topology. UE-bearer-specific Id, UE-specific Id, UE's access node IAB ID, or QoS information may be used (in combination or individually) on each hop to identify the PDU's QoS treatment. The PDU's QoS treatment may also be based on the LCID. Various information on the adaptation layer is processed to support the above functions on each on-path IAB-node (hop-by-hop), and/or on the UE's access-IAB-node and the IAB-donor (end-to-end).

Various options are available for placement of the adaptation layer into the L2 stack. For example, the adaptation layer can be integrated with, or placed above, the MAC layer but below the RLC layer. FIGS. 6A-B show two options for placement of the adaptation layer above MAC and below RLC. Alternately, the adaptation layer can be placed above RLC. Several examples of this alternative are shown in FIG. 6C-E and FIG. 7.

For one-to-one mapping of UE-bearers to backhaul RLC-channel, the adaptation layer should be integrated with the MAC layer or placed above the MAC layer. A separate RLC-entity in each IAB node can be provided for each of these backhaul RLC-channels. Arriving PDUs can be mapped to the corresponding RLC-entity based on the UE-bearer information carried by the adaptation layer. When UE-bearers are aggregated to backhaul RLC-channels (e.g., based on QoS-profile), the adaptation layer can be placed above the RLC layer. For both of these options, when UE bearers are aggregated to logical channels, the logical channel can be associated to a QoS profile. The number of QoS-profiles supported is limited by the LCID-space.

The adaptation layer may consist of sublayers. It is conceivable, for example, that the GTP-U header becomes a part of the adaptation layer. It is also possible that the GTP-U header is carried on top of the adaptation layer (e.g., as shown in FIG. 6D) to carry end-to-end association between the IAB-node DU and the CU.

Alternatively, an IP header may be part of the adaptation layer or carried on top of the adaptation layer, such as shown in FIG. 6E. In this example, the IAB-donor DU holds an IP routing function to extend the IP-routing plane of the fronthaul to the IP-layer carried by adapt on the wireless backhaul. This allows native F1-U to be established end-to-end, i.e. between IAB-node DUs and IAB-donor CU-UP. The scenario implies that each IAB-node holds an IP-address, which is routable from the fronthaul via the IAB-donor DU. The IAB-nodes' IP addresses may further be used for routing on the wireless backhaul. Note that the IP layer on top of the adaptation layer does not represent a PDU session. As such, the MT's first hop router on this IP layer does not have to hold a UPF.

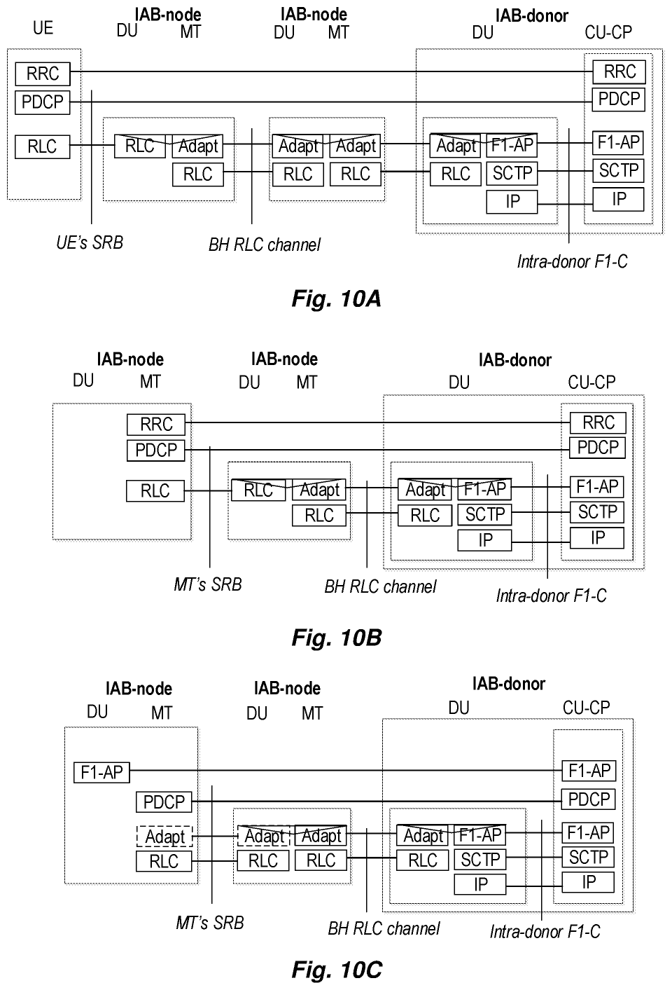

Although RLC channels serving for backhauling include the adaptation layer, it is for further study (FFS) if the adaptation layer is also included in IAB -node access links (e.g., adapt is dashed in FIG. 10). The specific design of the adaption header is not specified, but various alternatives are possible. Various other aspects of the placement of the adaptation layer can be considered. For example, an above-RLC adaptation layer can only support hop-by-hop ARQ. The above-MAC adaptation layer can support both hop-by-hop and end-to-end ARQ. On the other hand, both adaptation layer placements can support aggregated routing (e.g., by inserting an IAB-node address into the adaptation header) and both adaptation layer placements can support per-UE-bearer QoS treatment. In order for each UE bearer to receive individual QoS support when their number exceeds the size of the LCID space, the LCID space might be extended, e.g., by changes to the MAC sub-header or by dedicated information placed in the adaptation layer header. It is to be determined whether eight groups for uplink BSR reporting is sufficient, or whether the scheduling node has to possess better knowledge of which DRB has uplink data.

It is possible that the UE-specific ID, if used, will be a completely new identifier; alternatively, one of the existing identifiers can be reused. The identifiers included in the adaptation layer header may vary, depending on the adaptation layer placement. For above-RLC adaptation layer, the LCID space has to be enhanced since each UE-bearer is mapped to an independent logical channel For above-MAC adaptation layer, UE-bearer-related info has to be carried on the adaptation header.

In addition, both adaptation layer placements can support aggregated QoS handling, in the following example network configurations: (a) For above-RLC adaptation layer placement, UE bearers with the same QoS profile could be aggregated to one backhaul RLC channel for this purpose; (b) for above-MAC or integrated-with-MAC adaptation layer, UE bearers with the same QoS profile could be treated with the same priority by the scheduler. In addition, for both adaptation layer placements, aggregation of routing and QoS handling allows proactive configuration of intermediate on-path IAB-nodes, i.e., configuration is independent of UE-bearer establishment/release. Likewise, for both adaptation layer placements, RLC ARQ can be pre-processed on TX side.

For RLC AM, ARQ can be conducted hop-by-hop along access and backhaul links, such as illustrated in FIGS. 6C-6E and FIG. 7. It is also possible to support ARQ end-to-end between UE and IAB-donor, such as illustrated in FIGS. 6A-6B. Since RLC segmentation is a just-in-time process it is always conducted in a hop-by-hop manner For end-to-end multi-hop RLC ARQ, the adaptation layer should be integrated with, or placed above, MAC layer. In contrast, there is dependence between adaptation and MAC layers for multi-hop RLC ARQ conducted hop-by-hop.

Table 1 below provides a summary comparison between end-to-end and hop-by-hop RLC ARQ.

| Metric | Hop-by-hop RLC ARQ | End-to-end RLC ARQ |
|---|---|---|
| Forwarding | Potentially higher as packets have | Potentially lower as packets do not |
| latency | to pass through RLC-state machine | go through the RLC state machine |
| | on each hop. | on intermediate IAB-nodes. |
| Latency due to | Independent of number of hops | Increases with number of hops |
| retransmission | | |
| Capacity | Packet loss requires retransmission | Packet loss may imply |
| | only on one link. Avoids redundant | retransmission on multiple links, |
| | retransmission of packets over | including those where the packet |
| | links where the packet has already | was already successfully |
| | been successfully transmitted. | transmitted. |
| Hop count | Hop count is not affected by max | Hop count may be limited by the |
| limitation due to | window size. | end-to-end RLC latency due to |
| RLC parameters | | max window size. |
| Hop count | Hop count may be limited by | Hop count does not impact |
| limitation due to | increasing disorder of PDCP PDUs | disorder of PDCP PDUs due to |
| PCDP | over sequential RLC ARQ hops. | RLC ARQ. |
| parameters | | |
| | This may increase probability to | |
| | exceed max PDCP window size. | |
| Processing and | Larger since processing and | Smaller since intermediate path- |
| memory impact | memory can be required on | nodes do not need ARQ state |
| on intermediate | intermediate IAB-nodes. | machine and flow window. |
| IAB-nodes | | |
| RLC | No stage-3 impact expected | Potential stage-3 impact |
| specification | | |
| impact | | |
| Operational | IAB-nodes and IAB-donors use the | End-to-end RLC ARQ results in a |
| impact for IAB- | same hop-by-hop RLC ARQ. As a | greater architectural difference |
| node to IAB- | result, this functionality is | between IAB nodes vs. IAB donor |
| donor upgrades | completely unaffected by the | nodes. As a result, additional |
| | upgrade of IAB-node to IAB-donor | effort can be required to complete |
| | at availability of fiber, potentially | an upgrade of an IAB node to an |
| | reducing the effort required to | IAB donor upon availability of |
| | confirm proper operation. | fiber. |
| Configuration | RLC timers are not dependent on | RLC timers become hop-count |
| complexity | hop-count. | dependent. |

The CP protocol in the F1 interface (F1-C) is described as follows. A F1-C signalling bearer provides various functions including reliable transfer of F1AP messages over the F1-C interface, networking and routing, redundancy in the signalling network, and support for flow control and congestion control. The F1AP protocol provides the F1-C RNL, while the F1-C TNL is provided by Stream Control Transmission Protocol (SCTP) on top of IP (e.g., IPv4 and/or IPv6). The IP layer of F1-C only supports point-to-point transmission for delivering an F1AP message. Any suitable Data Link Layer protocol (e.g. PPP, Ethernet, etc.) can be used under IP. The gNB-CU and gNB-DU shall support the Diffserv Code Point marking as described in IETF RFC 2474.

SCTP is a connection oriented protocol that offers transport services similar to transmission control protocol (TCP), but differs from TCP in at least two important ways. First, whereas a TCP connection is usually one-to-one between endpoints (e.g. server and client network interfaces), an SCTP association can be many-to-many (e.g., multiple client IP addresses, multiple server IP addresses). Second, SCTP has extended the concept of a connection between two nodes to include streams. An SCTP association can contain from 1 to 65535 streams. All user data that is delivered over the association must be assigned to a stream. For example, stream 0 could carry control instructions, while stream 1 could carry small pieces of data (e.g., small files), and stream 2 could carry larger pieces of data. The streams comprising an association deliver data independently of each other (i.e., transmission error or congestion on one stream doesn't affect other streams). This is a big advantage over TCP in that it can eliminate the head of line problem that can occur in TCP.

Like TCP, an SCTP association between endpoints must be established before any data (e.g., F1AP messages) can be sent over SCTP. Due to the many-to-many property discussed above, SCTP supports multi-homing where packets can traverse different paths, e.g., between different source and destination IP addresses that are part of the association. This multi-homing with multiple IP addresses at one or both SCTP endpoints also facilitates transport network redundancy. For SCTP endpoint redundancy, an INIT may be sent from gNB-CU or gNB-DU, at any time for an already established SCTP association, which shall be handled as defined in IETF RFC 4960 in sub clause 5.2.

For F1AP between gNB-CU and gNB-DU, the SCTP Payload Protocol Identifier (PPI) assigned by IANA is 62, while the SCTP Destination Port number assigned by IANA is 38472. The gNB-DU and gNB-CU shall support a configuration with a single SCTP association per gNB-DU/gNB-CU pair. Configurations with multiple SCTP endpoints per gNB-DU/gNB-CU pair should be supported. When configurations with multiple SCTP associations are supported, the gNB-CU may request to dynamically add/remove SCTP associations between the gNB-DU/gNB-CU pair. The gNB-DU shall establish the SCTP association.

Within the set of SCTP associations established between one gNB-CU/DU pair, a single SCTP association shall be employed for F1AP elementary procedures that utilize non-UE-associated signalling with the possibility of fail-over to a new association to enable robustness. Selection of the SCTP association by the gNB-DU and the gNB-CU is specified in 3GPP TS 38.401 (version 15.2.0). The following conditions apply to a gNB-CU/DU pair:
A single pair of stream identifiers shall be reserved over an SCTP association for the sole use of F1AP elementary procedures that utilize non-UE-associated signalling.
At least one pair of stream identifiers over one or several SCTP associations shall be reserved for the sole use of F1AP elementary procedures that utilize UE-associated signalling. However, more than one pair should be reserved.
For a single UE-associated signalling, the gNB-DU shall use one SCTP association and one SCTP stream, and the association/stream should not be changed during the communication of the UE-associated signalling unless TNL binding update is performed.

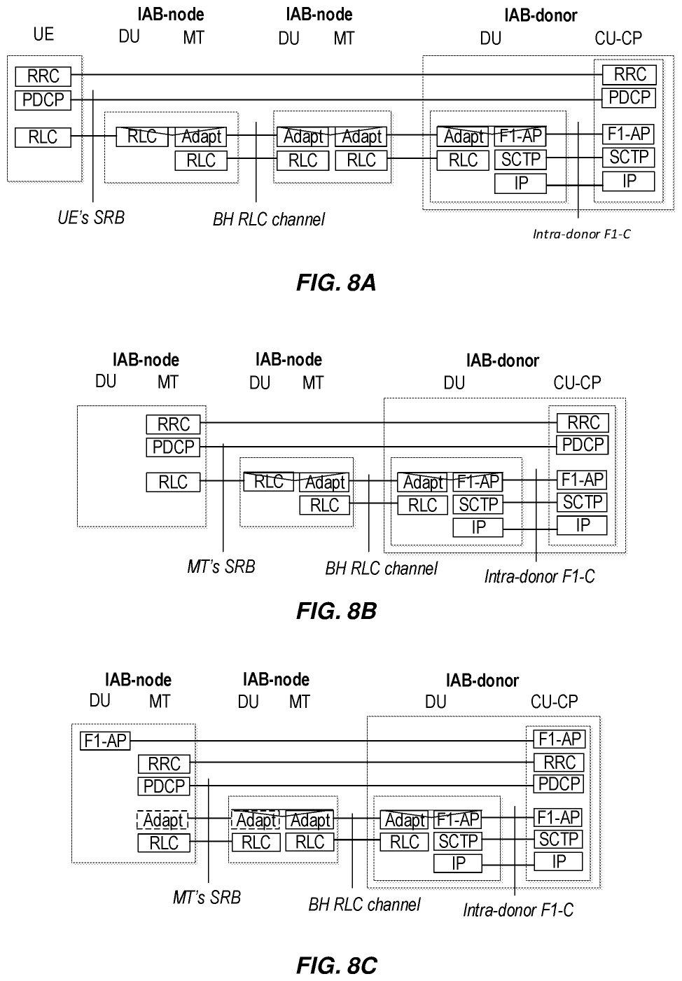

The following discussion relates to control-plane (CP) considerations for IAB architecture group 1. FIGS. 8A-C show exemplary UE RRC, MT RRC, and DU F1-AP protocol stacks for a first alternative of architecture 1a, also referred to as “alternative 1”. In this alternative, the adaptation layer is placed on top of RLC, and RRC connections for UE RRC and MT RRC are carried over a signalling radio bearer (SRB). On the UE's or MT's access link, the SRB uses an RLC-channel.

On the wireless backhaul links, the SRB's PDCP layer is carried over RLC-channels with adaptation layer. The adaptation layer placement in the RLC channel is the same for CP as for UP. The information carried on the adaptation layer may be different for SRB than for data radio bearer (DRB). The DU's F1-AP is encapsulated in RRC of the collocated MT. F1-AP is therefore protected by the PDCP of the underlying SRB. Within the IAB-donor, the baseline is to use native F1-C stack.

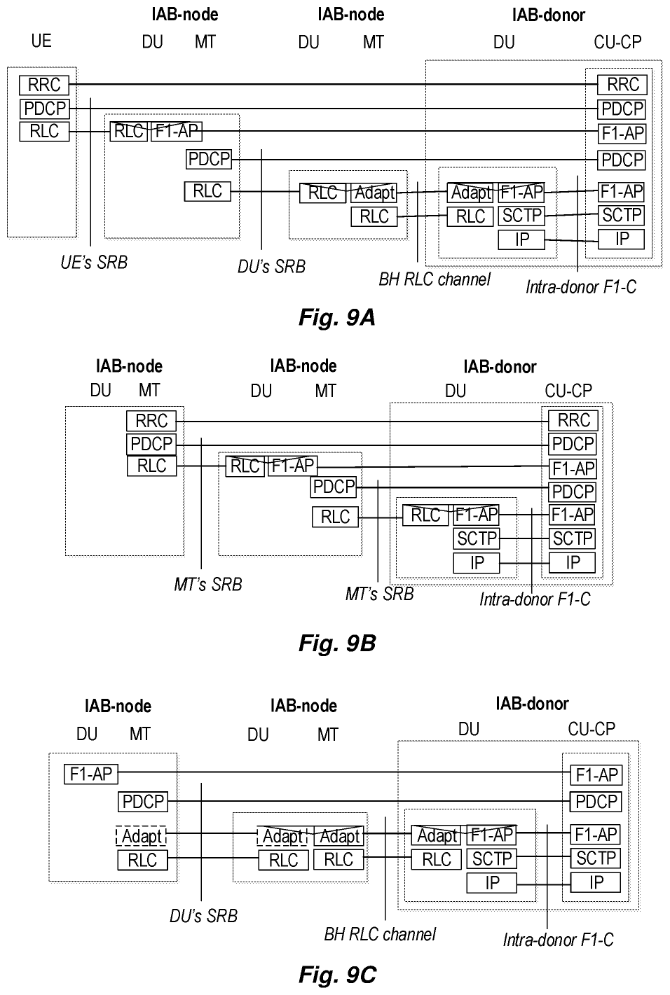

FIGS. 9A-9C show exemplary UE RRC, MT RRC, and DU F1-AP protocol stacks for a second alternative of architecture 1a, also referred to as “alternative 2”. Similar to alternative 1, RRC connections for UE RRC and MT RRC are carried over a signalling radio bearer (SRB), and the SRB uses an RLC-channel on the UE's or MT's access link.

In contrast, on the wireless backhaul links, the SRB's PDCP layer is encapsulated into F1-AP. The DU's F1-AP is carried over an SRB of the collocated MT. F1-AP is protected by this SRB's PDCP. On the wireless backhaul links, the PDCP of the F1-AP's SRB is carried over RLC-channels with adaptation layer. The adaptation layer placement in the RLC channel is the same for CP as for UP. The information carried on the adaptation layer may be different for SRB than for DRB. Within the IAB-donor, the baseline is to use native F1-C stack.

FIGS. 10A-10C show exemplary UE RRC, MT RRC, and DU F1-AP protocol stacks for a third alternative, also referred to as “alternative 3”. In this alternative, the adaptation layer is placed on top of RLC, and RRC connections for UE and MT are carried over a signalling radio bearer (SRB). On the UE's or MT's access link, the SRB uses an RLC-channel. On the wireless backhaul links, the SRB's PDCP layer is carried over RLC-channels with adaptation layer. The adaptation layer placement in the RLC channel is the same for CP as for UP. The information carried on the adaptation layer may be different for SRB than for data radio bearer (DRB). The DU's F1-AP is also carried over an SRB of the collocated MT. F1-AP is therefore protected by the PDCP of this SRB. On the wireless backhaul links, the PDCP of the this SRB is also carried over RLC-channels with adaptation layer. Within the IAB-donor, the baseline is to use native F1-C stack.

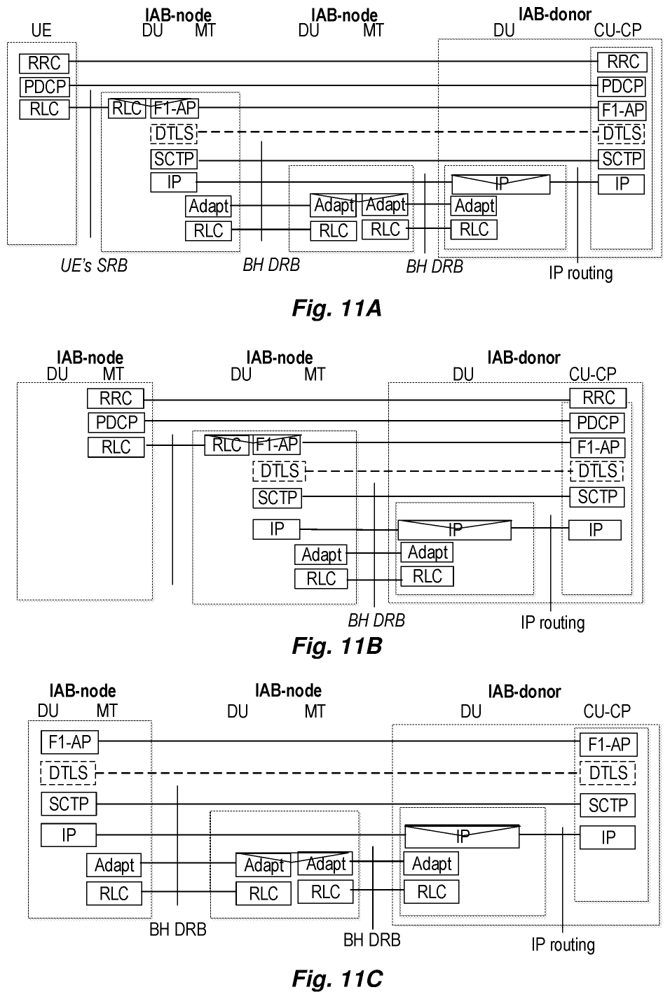

FIGS. 11A-11C show exemplary UE RRC, MT RRC, and DU F1-AP protocol stacks for a fourth alternative, also referred to as “alternative 4”. In this alternative, the adaptation layer is placed on top of RLC, and all F1-AP signalling is carried over SCTP/IP to the target node. The IAB-donor maps DL packets based on target node IP to adaptation layer used on backhaul DRB. Separate backhaul DRBs can be used to carry F1-AP signalling from F1-U related content. For example, mapping to backhaul DRBs can be based on target node IP address and IP layer Diffserv Code Points (DSCP) supported over F1 as specified in 3GPP TS 38.474 (version 15.1.0).

In alternative 4, a DU will also forward other IP traffic to the IAB node (e.g., OAM interfaces). The IAB node terminates the same interfaces as a normal DU except that the L2/L1 protocols are replaced by adaptation/RLC/MAC/PHY-layer protocols. F1-AP and other signalling are protected using NDS (e.g., IPSec, DTLS over SCTP) operating in the conventional way between DU and CU. For example, SA3 has recently adopted the usage of DTLS over SCTP (as specified in IETF RFC6083) for protecting F1-AP.

Topology adaptation can be used to change and/or modify an IAB network topology to insure that an IAB node can continue to operate (e.g., providing coverage and end user service continuity) even if the IAB node's current active backhaul path is degraded or lost. Furthermore, it is also desirable to minimize service disruption and packet loss during topology adaptation. IAB topology adaptation can be triggered by integration of a IAB node to the topology, detachment of an IAB node from the topology, detection of backhaul link overload, deterioration of backhaul link quality or link failure, or other events.

Topology adaptation can include the following tasks:
Information collection—information includes backhaul link quality, link- and node-load, neighbor-node signal strength, etc. Such information should be collected over a sufficiently large area of the IAB topology to be meaningful.
Topology determination—deciding best topology based on the collected info and following a performance objective.
Topology reconfiguration—adjusting topology based on topology determination, e.g. establishing new connections, releasing other connections, changing routes, etc.

The following discussion mainly focuses on topology reconfiguration. In this discussion, it is assumed that existing Rel-15 procedures for measurements, handover, dual-connectivity and F1-interface management are baseline for topology reconfiguration in architecture 1. Furthermore, Rel-16 related procedures should be considered when these procedures are available.

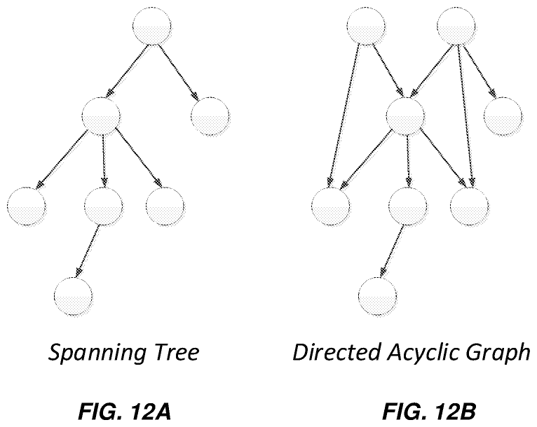

FIG. 12 shows two exemplary topologies considered for IAB Topology Adaptation. More specifically, FIG. 12A shows a spanning tree (ST) topology, in which there is only one route between each IAB-node and IAB-donor. In architecture group 1, where the IAB-donor holds one CU with one or multiple DUs, the graph underneath each IAB-donor DU represents a separate ST.

In contrast, FIG. 12B shows a directed acyclic graph (DAG) topology. In DAG-topologies, redundant routes are supported between each IAB-node and the CU. In architecture group 1, such route redundancy may involve multiple IAB-donor-DUs. Topologically redundant routes may simultaneously run traffic. It is also possible to keep one route active and assign backup status to a redundant route. In order to separate this case from the ST topology which could be dynamically reconfigured, we assume at least control plane connectivity is simultaneously maintained on all paths in the DAG topology.

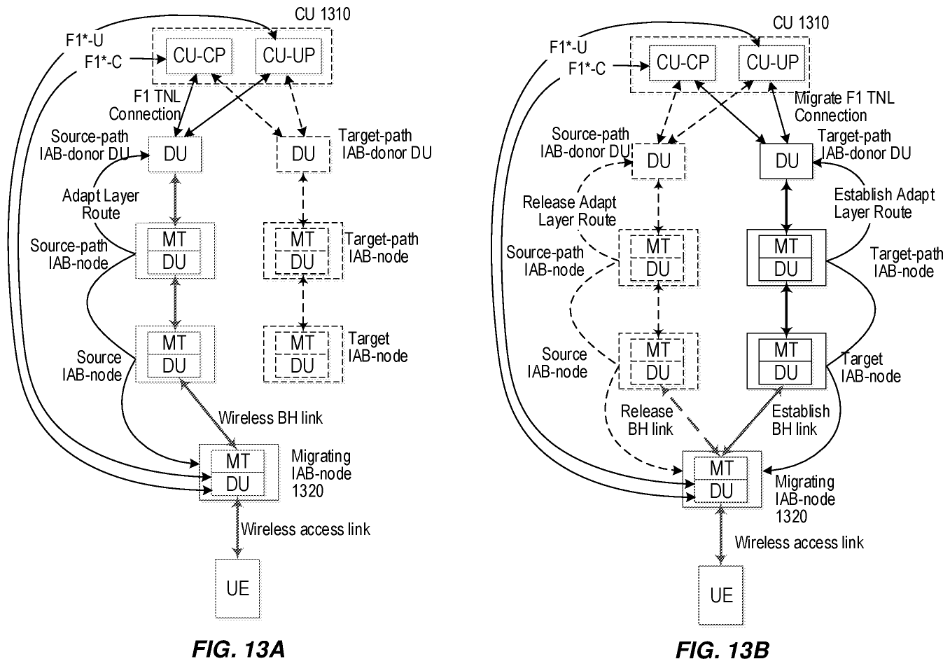

The following discussion focuses on the procedure for adaptation within an ST topology using architecture 1a. This discussion primarily addresses topology changes underneath the IAB-donor. FIG. 13 illustrates an ST topology adaptation, where a particular node (labelled “migrating IAB node”) changes its attachment point (“migrates”) from a source parent node to a target parent node. The exemplary topology shown in FIG. 13 includes five IAB nodes connected to an IAB-donor which holds two DUs, with the migrating IAB-node having one UE attached. FIG. 13A shows the topology before the migration. FIG. 13B shows the topology after migration, and indicates the links and routes that are established and released.

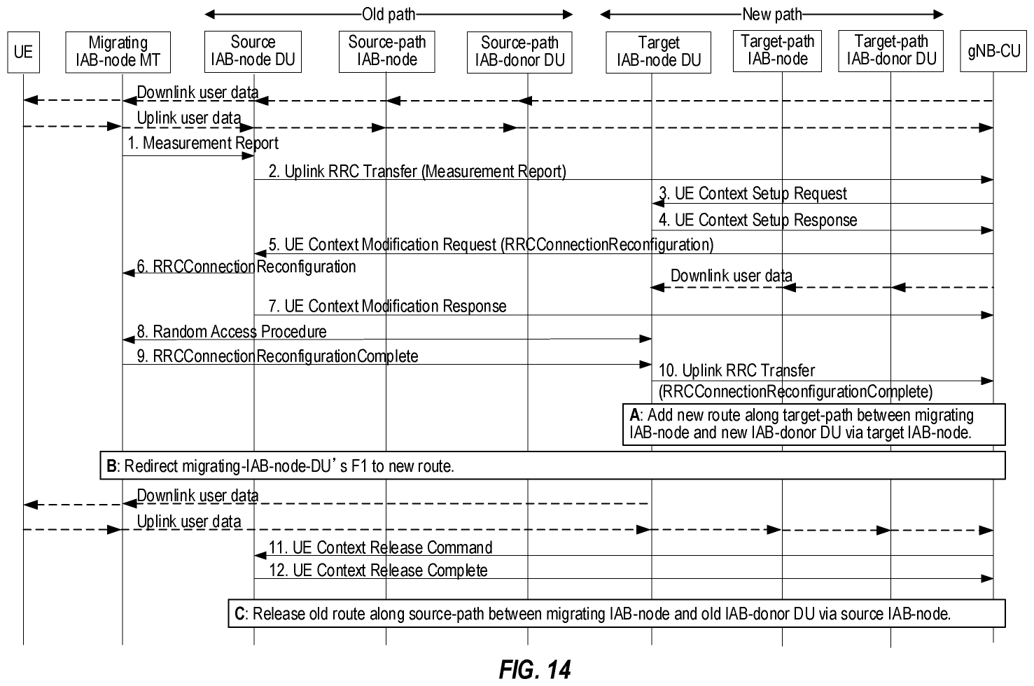

FIG. 14 shows a signal flow diagram of a procedure corresponding to the adaptation of an ST IAB topology (e.g., changing the attachment point of the migrating IAB node) as illustrated in FIG. 13. Here it is assumed that topology adaptation is initiated by the CU based on measurements reported by the migrating IAB node's MT. The CU's topology adaptation decision can include measurements by other IAB nodes. The measurements may be based on a measurement configuration the IAB nodes received from the CU before.

In the procedure illustrated by FIG. 14, the migrating IAB-nodes' MT applies the steps of Inter-gNB-DU mobility as described in 3GPP TS 38.401 (version 15.2.0) section 8.2.1.1 (solid and dashed lines). Additional signalling is supported for route changes of on-path IAB-nodes and on-path IAB-donor DUs (boxes labelled A-C).

In FIG. 14 and in the following description, numerical or alphabetical labels are given to the various operations of the procedure. However, these labels are used merely to simplify and/or clarify of the explanation of the procedure, and are not intended to strictly limit the operations to occur according to the numerical order of the labels. In other words, the various operations can be performed in different orders than shown, and/or be combined or separated into various other operations.

In operation 1, the MT sends a Measurement Report message to the source IAB-node-DU. This report is based on a Measurement Configuration the migrating-IAB-node's MT received from the IAB-donor CU before. In operation 2, the source IAB-node-DU sends an Uplink RRC Transfer message to the gNB-CU to convey the received Measurement Report. In operation 3, the gNB-CU sends a UE Context Setup Request message to the target IAB-node-DU to create an MT context and setup one or more bearers. With respect to an IAB configuration, these bearers are used by the MT for its own data and signalling traffic. In addition, one or more RLC-channels are established for backhauling.

In operation 4, the target IAB-node-DU responds to the gNB-CU with an UE Context Setup Response message. In operation 5, the gNB-CU sends a UE Context Modification Request message to the source IAB-node-DU, which includes a generated RRCConnectionReconfiguration message and indicates to stop the data transmission for the MT. With respect to an IAB configuration, the retransmission of PDCP PDUs and the use of Downlink Data Delivery Status (DDDS) as discussed in 3GPP TS 38.425 (version 15.2.0) clause 5.4.2 is for further study (FFS).

In operation 6, the source IAB-node DU forwards the received RRCConnectionReconfiguration message to the MT. In operation 7, the source IAB-node-DU responds to the gNB-CU with the UE Context Modification Response message. In operation 8, a Random Access procedure is performed at the target IAB-node-DU. In operation 9, the MT responds to the target IAB-node -DU with an RRCConnectionReconfigurationComplete message. In operation 10, The target IAB-node-DU sends an Uplink RRC Transfer message to the gNB-CU to convey the received RRCConnectionReconfigurationComplete message. Downlink packets are sent to the MT. Also, uplink packets are sent from the MT, which are forwarded to the gNB-CU through the target IAB-node-DU.

Concerning the IAB-related operations that occur in the box labelled “A” (also referred to as “operation A”), the gNB-CU configures a new adaptation-layer route (also referred to as a “target path”) on the wireless backhaul between migrating IAB-node and IAB-donor DU via the target IAB-node. It further configures a forwarding entry between the fronthaul on the new route on the wireless backhaul. These configurations may be performed at an earlier stage, e.g., after operation 4. The details of this operation depend on the particular UP and CP transport option (see below).

In the IAB-related operations that occur in the box labelled “B” (also referred to as “operation B”), the gNB-CU redirects all F1-U tunnels for the migrating-IAB-node DU from the old route (also referred to as “source path”) to the new route. It further redirects F1-C for the migrating-IAB-node DU from the old route to the new route. While operation B has to follow operation A it may be performed at an earlier stage as described under operation A. The details of this operation depend on the particular UP and CP transport option (discussed below).

In operation 11, the gNB-CU sends an UE Context Release Command message to the source IAB-node-DU. In operation 12, the source IAB-node-DU releases the MT context and responds to the gNB-CU with an UE Context Release Complete message. In the IAB-related operations that occur in the box labelled C (also referred to as “operation C”), the gNB-CU releases the old adaptation-layer route on the wireless backhaul between migrating IAB-node and IAB-donor DU via the source IAB-node. It further releases the forwarding entry between the fronthaul on the old route on the wireless backhaul. The detailed operations depend on the particular UP and CP transport option (see below).

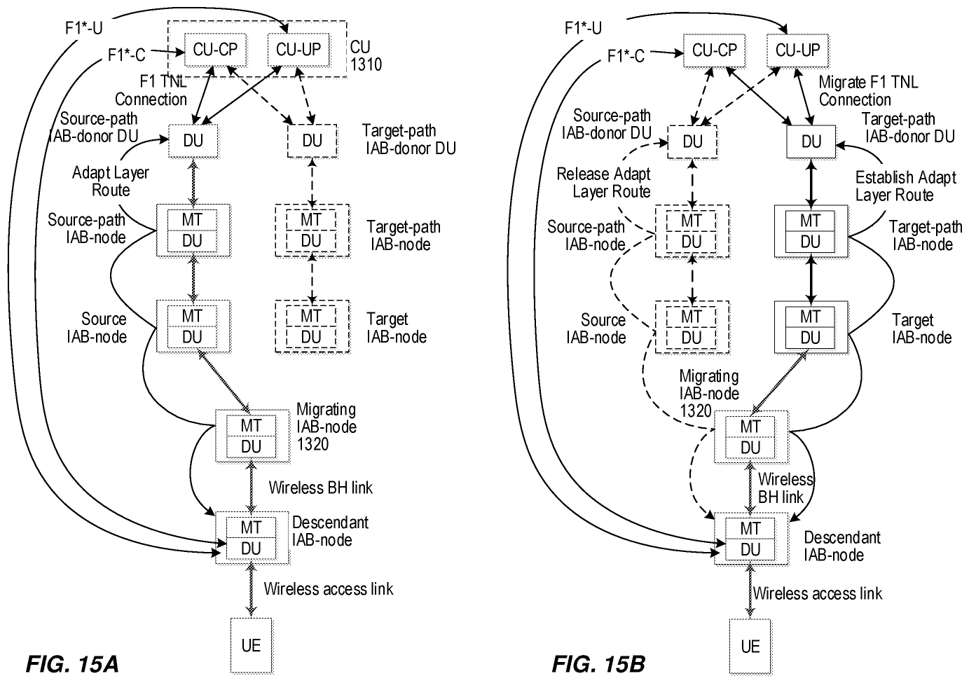

FIG. 15 shows an exemplary ST topology adaptation in which the migrating IAB node has a descendent IAB node. One point to note from FIG. 15 is that operations A, B, and C shown in FIG. 14 should also be performed for all IAB-nodes that are descendant to the migrating IAB-node.

As noted above, the details of operations A-C described above depend on the particular UP and CP transport options used. For example, in operation A (establishment of new route), route establishment uses the same procedure as during IAB-node setup. Routing entries need to be configured for at least all IAB nodes within the section of the new route that does not overlap with the old route. In case new routing identifiers are used for the new route, all IAB -nodes on the new route need to be configured.

Furthermore, in operation A, a forwarding entry needs to be configured on the new IAB-donor DU to interconnect the TNL between IAB -donor DU and CU with the new adaptation-layer route between the new IAB-donor DU and the migrating IAB-node. The details of this forwarding entry depend on the identifiers used for routing on the wireless backhaul. In case the migrating IAB-node supports an IP-address on the adaptation layer (e.g. CP alternative 4), which is derived from a fronthaul IP-prefix owned by the IAB-donor DU, the IAB-node needs to obtain a new IP address when the IAB-donor DU changes. The new IP address can be obtained in the same manner as during IAB -node setup.

In operation A, if end-to-end RLC is supported between UE and IAB-donor DU, IAB-topology adaptation as discussed in this context can be performed in two ways. First, the entire RLC-state can be migrated from the old IAB-donor DU to the new IAB-donor DU, which can remain transparent to the UE. Second, the RLCs of all the bearers of all the UEs under the migrating IAB node and the UEs under the descendant IAB nodes of the migrating IAB node are reset and re-established, which is not transparent to the UEs.

On the other hand, if hop-by-hop RLC is supported between UE and IAB-donor DU, IAB-topology adaptation as discussed in this context may lead to data loss for UL traffic. 3GPP TR 38.874 (version 0.2.1) section 8.2.3 discusses potential remedies for this issue, which will not be described in more detail here.

With respect to operation B (redirection of F1-U tunnels and F1-AP onto new route), if the IAB-donor-DU changes during topology adaptation, the downlink (DL) F1 TNL endpoints have to be reconfigured. The TNL addresses for F1 are either those of the IAB-donor-DU (CP alternatives 1, 2, and 3) or of the migrating IAB-node (CP alternative 4). In the latter case, the migrating IAB-node's IP address changes during topology adaptation as discussed with respect to operation A.

In operation B, if the GTP-U tunnels for the IAB node are terminated at the source IAB-donor DU (e.g. UP alternatives a, b and c), these tunnels need to be moved to the target IAB-donor DU. It is assumed this can be done by allocating new GTP TEIDs when the forwarding is updated in the target IAB-donor DU. Furthermore, if an F1-AP/SCTP connection between the CU and donor-DU is used to deliver a CP message towards the IAB node (e.g., CP alternative 1-3), the F1-AP/SCTP connection between the CU and the target IAB-donor DU needs to be updated to allow forwarding of CP message to the IAB node.

With respect to operation C (release of old route), routing entries of the old route are released as long as they are not used for forwarding on the new path. Also, forwarding entries are released on the old IAB-donor DU that interconnect the TNL between IAB-donor DU and CU with the old adaptation-layer route. The details of this forwarding entry depend on the identifiers used for routing on the wireless backhaul.

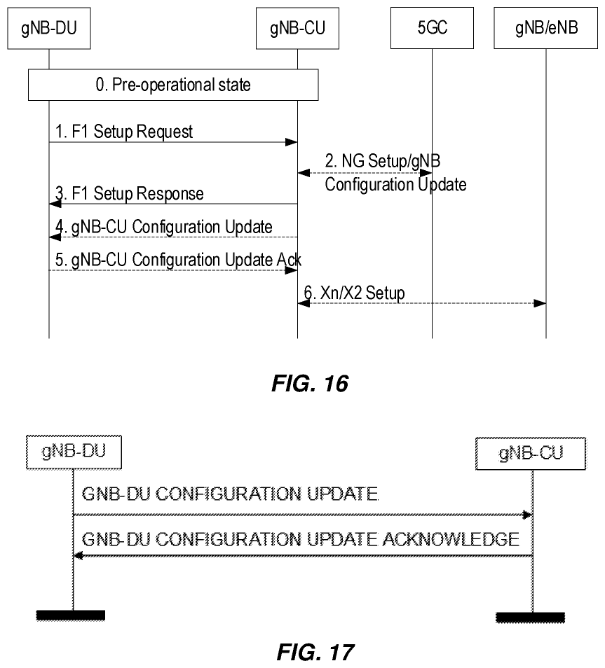

These issues discussed above in relation to FIGS. 14-15 are further illustrated by the following description related to FIGS. 16-21. FIG. 16 shows a signal flow diagram for an exemplary F1 setup and cell activation procedure. In FIG. 16 and in the following description, numerical labels are given to the various operations of the procedure. However, these labels are used merely to clarify and/or simplify the explanation of the procedure, and are not intended to strictly limit the operations to occur according to the numerical order of the labels. In other words, the various operations can be performed in different orders than shown, and/or be combined or separated into various other operations.

In operation 0, the gNB-DU and its cells are configured by an operations and maintenance (OAM) entity to be in the F1 pre-operational state. The gNB-DU gets the IP address of the gNB-CU and sends an SCTP INIT to the CU (IP address of CU, fixed port number 38472). When the gNB-CU replies to this SCTP initialization request, the gNB-DU has TNL connectivity toward the gNB-CU. In operation 1, the gNB-DU sends an F1 Setup Request message to the gNB-CU including a list of cells that are configured and ready to be activated.

In operation 2, the gNB-CU ensures the connectivity between the NG-RAN and the core network (5GC). For this reason, the gNB-CU may initiate either the NG Setup or the gNB Configuration Update procedure towards 5GC. In operation 3, the gNB -CU sends an F1 Setup Response message, to the gNB-DU, that optionally includes a list of cells to be activated. If the gNB-DU succeeds in activating the cell(s), then the cells become operational. Note that in case that the F1 Setup Response is not used to activate any cell, operation 2 may be performed after operation 3.

If the gNB-DU fails to activate some cell(s), the gNB-DU may initiate the gNB-DU Configuration Update procedure towards the gNB-CU. In this case, The gNB-DU includes in the gNB-DU Configuration Update message the cell(s) that are active (i.e., the cell(s) for which the gNB-DU should be able to serve UEs). The gNB-DU may also indicate that the cell(s) that failed to activate should be deleted, in which case the gNB-CU removes the corresponding cell(s) information.

In operation 4, the gNB-CU may send a gNB-CU Configuration Update message to the gNB-DU that optionally includes a list of cells to activated, e.g., in case that these cells were not activated using the F1 Setup Response message. In operation 5, the gNB-DU replies with a gNB-DU Configuration Update Acknowledge message that optionally includes a list of cells that failed to be activated. In operation 6, the gNB-CU may initiate either the Xn Setup towards a neighbour NG-RAN node or the EN-DC X2 Setup procedure towards a neighbour eNB.

Over the F1 interface between a gNB-CU and a gNB-DU pair, two cell states are possible: 1) an Inactive state, where the cell is known by both the gNB-DU and the gNB-CU, but does not serve UEs; and 2) an Active state, where the cell is known by both the gNB-DU and the gNB-CU, and should be able to serve UEs. The gNB-CU decides whether the cell state should be Inactive or Active. The gNB-CU can request the gNB-DU to change the cell state using F1 Setup Response, gNB-DU Configuration Update Acknowledge, or gNB-CU Configuration Update messages. The gNB-DU can confirm (or reject) a request to change the cell state using the gNB-DU Configuration Update or the gNB-CU Configuration Update Acknowledge messages.

FIG. 17 shows a signal flow diagram for successful operation of an exemplary gNB-DU Configuration Update procedure. The purpose of this procedure is to update application-level configuration data needed for the gNB-DU and the gNB-CU to interoperate correctly on the F1 interface. This procedure uses non-UE associated signalling and does not affect any existing UE-related contexts. The gNB-DU initiates the procedure by sending a gNB-DU Configuration Update message to the gNB-CU including an appropriate set of updated configuration data that it has just taken into operational use. The gNB-CU responds with a gNB-DU Configuration Update Acknowledge message to acknowledge that it successfully updated the configuration data. The updated configuration data should be stored in both nodes and used as long as there is an operational TNL association or until any further update is performed.

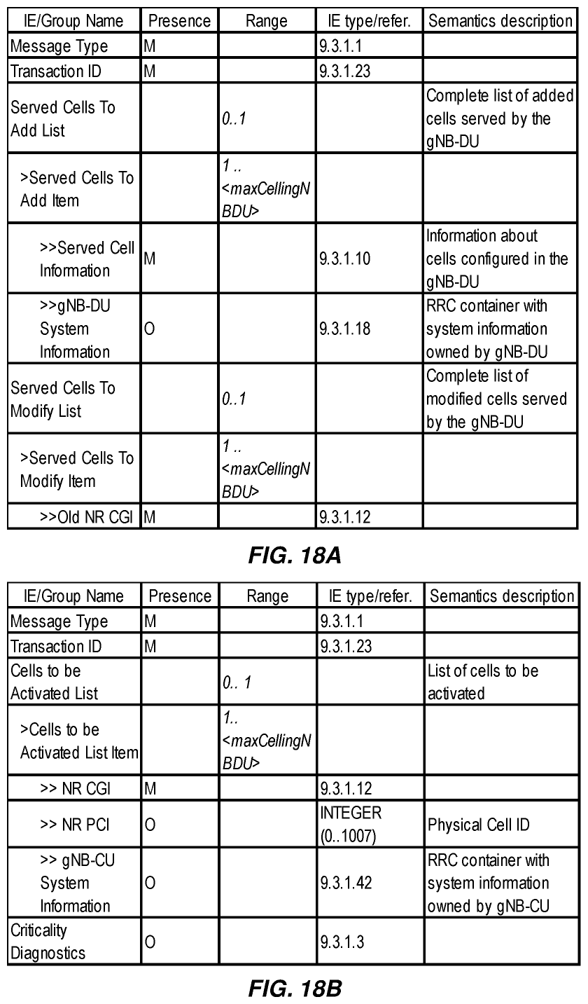

FIG. 18A shows an exemplary structure of a gNB-DU Configuration Update message. FIG. 18B shows an exemplary structure of a gNB-DU Configuration Update Acknowledge message. The following discussion relates to various fields (or information elements, “IEs”) shown in FIG. 18.

If Served Cells To Add Item IE is contained in the gNB-DU Configuration Update message, the gNB-CU shall add cell information according to the information in the Served Cell Information IE. For NG-RAN, the gNB-DU shall include the gNB-DU System Information IE.

If Served Cells To Modify Item IE is contained in the gNB-DU Configuration Update message, the gNB-CU shall modify information of cell indicated by Old NR CGI IE according to the information in the Served Cell Information IE. Further, if the gNB-DU System Information IE is present the gNB-CU shall store and replace any previous information received.

If Served Cells To Delete Item IE is contained in the gNB-DU Configuration Update message, the gNB-CU shall delete information of cell indicated by Old NR CGI IE.

If Active Cells Item IE is contained in the gNB-DU Configuration Update message, the gNB-CU shall update the information about the cells that are currently active. If the Active Cells List is present and does not contain any cells, the gNB-CU shall assume that there are currently no active cells.

If Cells to be Activated Item IE is contained in gNB-DU Configuration Update Acknowledge message, the gNB-DU shall activate the cell indicated by NR CGI IE and reconfigure the physical cell identity for cells for which the NR PCI IE is included. Likewise, If Cells to be Activated List Item IE is contained in the gNB-DU Configuration Update Acknowledge message and the indicated cells are already activated, the gNB-DU shall update the cell information received in Cells to be Activated List Item IE.

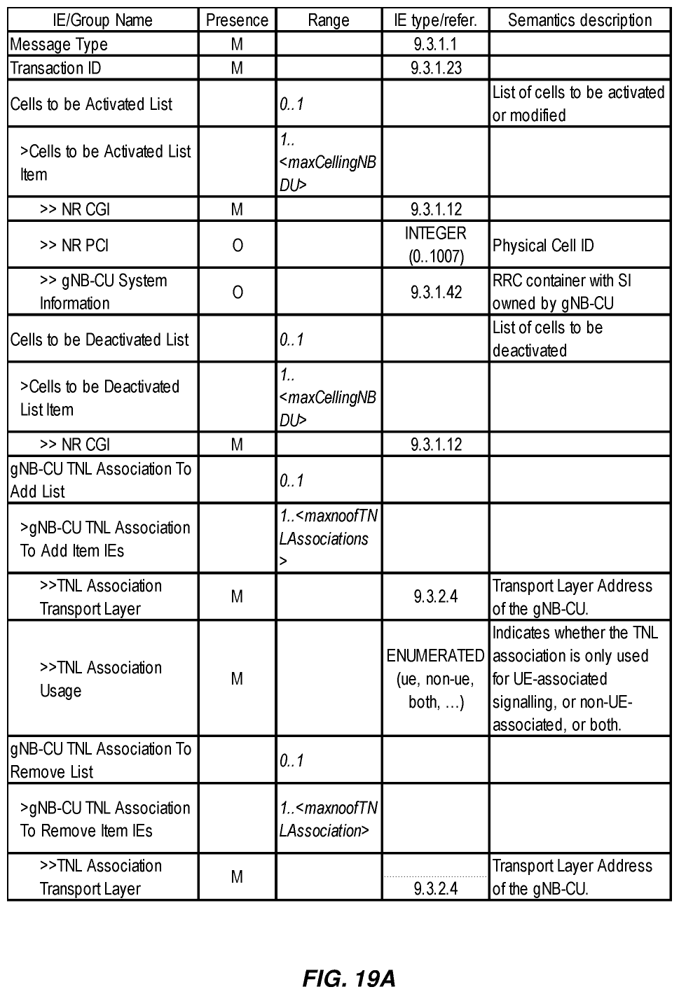

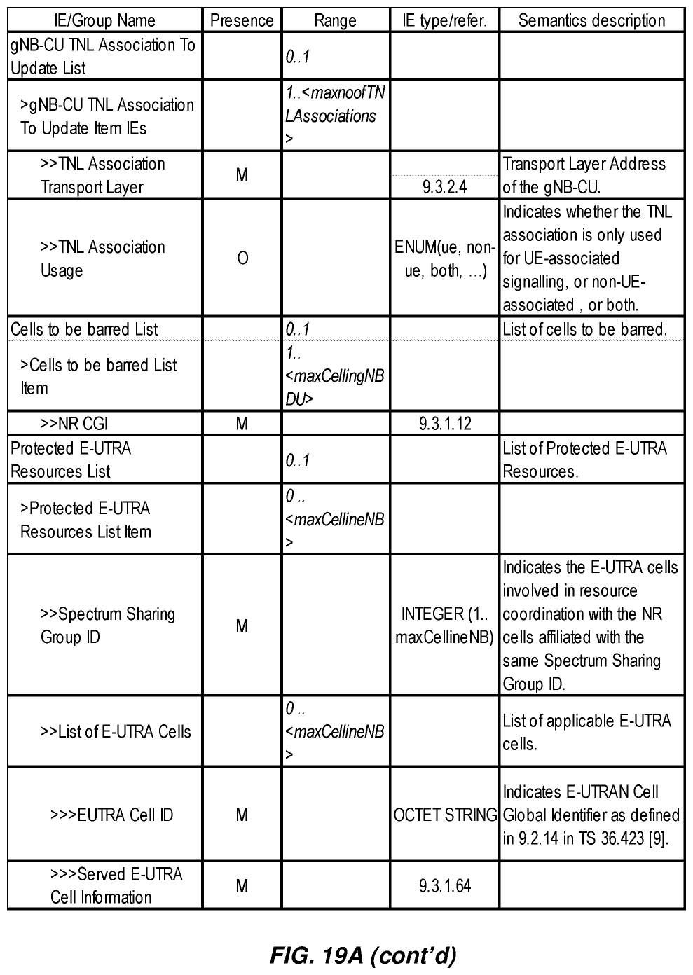

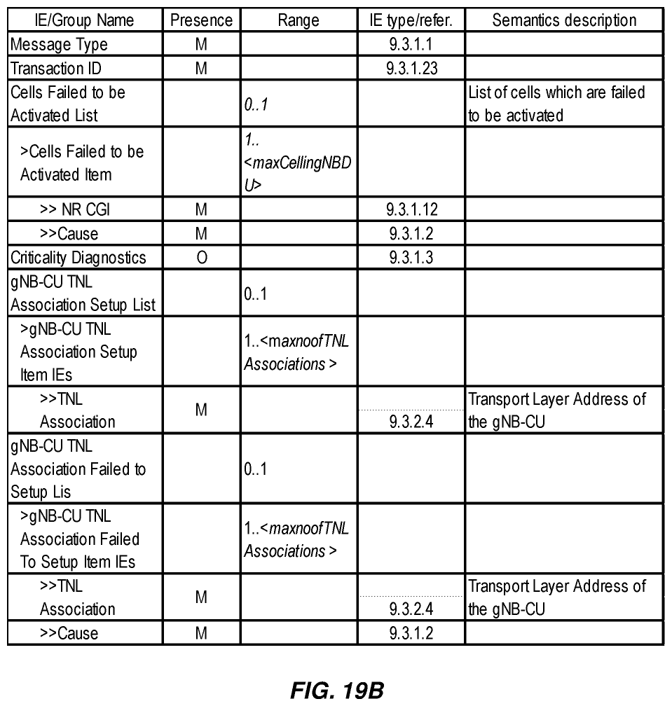

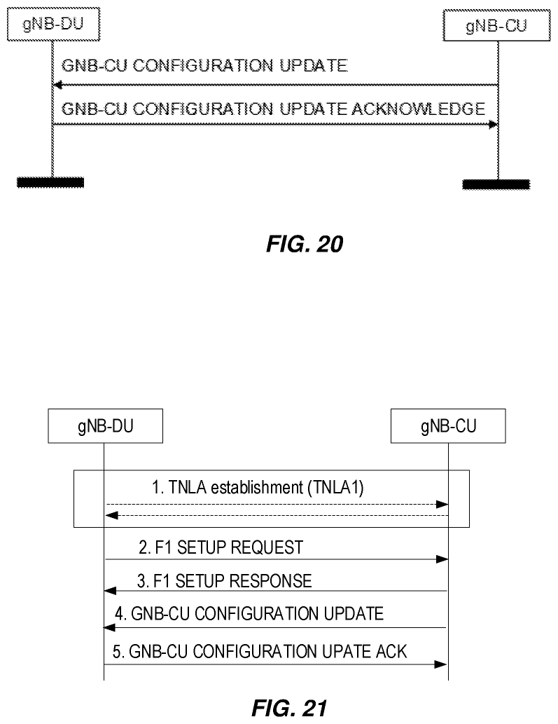

FIG. 20 shows a signal flow diagram for successful operation of an exemplary gNB-CU Configuration Update procedure, while FIG. 19 shows exemplary structure of various messages used in the exemplary procedure shown in FIG. 20. Similar to the procedure shown in FIG. 17, the purpose of this procedure is to update application level configuration data needed for the gNB-DU and the gNB-CU to interoperate correctly on the F1 interface. This procedure uses non-UE-associated signalling and does not affect any existing UE-related contexts. The gNB-CU initiates the procedure by sending a gNB-CU Configuration Update message to the gNB-DU including an appropriate set of updated configuration data that it has just taken into operational use. The gNB-DU responds with a gNB-CU Configuration Update Acknowledge message to acknowledge that it successfully updated the configuration data. The updated configuration data should be stored in both nodes and used as long as there is an operational TNL association or until any further update is performed.

FIG. 19A shows an exemplary structure of a gNB-CU Configuration Update message. FIG. 19B below shows an exemplary structure of a gNB-CU Configuration Update Acknowledge message. The following discussion relates to various fields (or information elements, “IEs”) shown in FIGS. 19A-B.

If Cells to be Activated List Item IE is contained in the gNB-CU Configuration Update message, the gNB-DU shall activate the cell indicated by NR CGI IE and reconfigure the physical cell identity for which the NR PCI IE is included.

If Cells to be Deactivated List Item IE is contained in the gNB-CU Configuration Update message, the gNB-DU shall deactivate the cell indicated by NR CGI IE.

If Cells to be Activated List Item IE is contained in the gNB-CU Configuration Update message and the indicated cells are already activated, the gNB-DU shall update the cell information received in Cells to be Activated List Item IE.

If the gNB-CU TNL Association To Add List IE is contained in the gNB-CU Configuration Update message, the gNB-DU shall, if supported, use it to establish the TNL association(s) with the gNB-CU. The gNB-DU shall report to the gNB-CU, in the gNB-CU Configuration Update Acknowledge message, the successful establishment of the TNL association(s) with the gNB-CU as follows:
A list of TNL address(es) with which the gNB-DU successfully established the TNL association shall be included in the gNB-CU TNL Association Setup List IE;
A list of TNL address(es) with which the gNB-DU failed to establish the TNL association shall be included in the gNB-CU TNL Association Failed To Setup List IE.

If the gNB-CU TNL Association To Remove List IE is contained in the gNB-CU Configuration Update message the gNB-DU shall, if supported, initiate removal of the TNL association(s) indicated by the received gNB-CU Transport Layer Address towards the gNB-CU. Likewise, if the gNB-CU TNL Association To Update List IE is contained in the gNB-CU Configuration Update message the gNB-DU shall, if supported, overwrite the previously stored information for the related TNL association.

If the TNL usage IE or the TNL Association Weight Factor IE is included in the gNB-CU TNL Association To Add List IE or the gNB-CU TNL Association To Update List IE, the gNB-DU node shall, if supported, use it as described in 3GPP TS 38.472 (version 15.1.0).

For NG-RAN, the gNB-CU shall include the gNB-CU System Information IE in the gNB-CU Configuration Update message.

If Protected E-UTRA Resources List IE is contained in the gNB-CU Configuration Update message, the gNB-DU shall protect the corresponding resource of the cells indicated by List of E-UTRA Cells IE for spectrum sharing between E-UTRA and NR.

If the gNB-CU Configuration Update message contains the Protected E-UTRA Resource Indication IE, the receiving gNB-DU should forward it to lower layers and use it for cell-level resource coordination. The gNB-DU shall consider the received Protected E-UTRA Resource Indication IE when expressing its desired resource allocation during gNB-DU Resource Coordination procedure. The gNB-DU shall consider the received Protected E-UTRA Resource Indication IE content valid until reception of a new update of the IE for the same gNB-DU.

FIG. 21 shows a signal flow diagram for an exemplary procedure for managing multiple TNL addresses (TNLAs) between a gNB-DU and a gNB-CU. In FIG. 21 and in the following description, numerical labels are given to the various operations of the procedure. However, these labels are used merely simplify and/or clarify the explanation of the procedure, and are not intended to strictly limit the operations to occur according to the numerical order of the labels. In other words, the various operations can be performed in different orders than shown, and/or be combined or separated into various other operations.

In operation 1, the gNB-DU establishes the first TNLA with the gNB-CU using a configured TNL address. In operation 2, once the TNLA has been established, the gNB-DU initiates the F1 Setup procedure to exchange application level configuration data. Operations 2-3 involve exchange of messages between gNB-CU and gNB-DU according to this procedure. Subsequently, when needed, the gNB-CU may add additional TNL Endpoint(s) to be used for F1-C signalling between the gNB-CU and the gNB-DU. This can be done using the gNB-CU Configuration Update procedure, which involves exchanging gNB-CU Configuration Update and gNB-CU Configuration Update Acknowledge messages (such as shown in FIGS. 19-20) in operations 4-5. As discussed above, the gNB-CU Configuration Update procedure also allows the gNB-CU to request the gNB-DU to modify or release TNLA(s).

The F1AP UE TNLA binding is between a F1AP UE association and a specific TNL association for a given UE. After the F1AP UE TNLA binding is created, the gNB-CU can update the UE TNLA binding by sending the F1AP message for the UE to the gNB-DU via a different TNLA. The gNB-DU shall update the F1AP UE TNLA binding with the new TNLA.

As discussed above in relation to FIGS. 14-15, if an IAB-donor-DU changes during topology adaptation, the downlink F1 TNL endpoints have to be reconfigured. The F1 TNL addresses are either those of the IAB-donor-DU (CP alternatives 1, 2, and 3) or of the migrating IAB-node (CP alternative 4). In the latter case, the migrating IAB-node's IP address changes during topology adaptation as discussed under operation A. Furthermore, if the GTP-U tunnels for the IAB node are terminated at the IAB-donor DU (e.g. UP alternative a, b and c), these tunnels also need to be moved to the target IAB-donor DU.

Currently, it is unclear how this relocation should be done. For example, the IAB node may be connected via one TNL address (IP address) prior to the IAB node relocation, while after the relocation a different TNL address is needed. This is a particular problem if the IAB node is relocated between two different DUs which have different IPv6 prefix. In these cases the IAB node will most likely also only be able to communicate via one radio link or path prior to the relocation and via the other radio link or path after relocation.

Exemplary embodiments of the present disclosure address these and other problems, challenges, and/or issues by providing methods and/or procedures for relocating and/or remapping the F1-C TNL association between the donor CU and the IAB node, when the IAB node hands over from one serving IAB node to another.

Exemplary embodiments include techniques for preparing the setup of a new SCTP association (e.g., to be used after relocation to a target path) prior to executing the relocation (e.g., while the IAB node is still communicating through the source path). When the IAB node has been relocated, either the IAB node (or donor CU) can initiate the setup of a new SCTP association towards the donor CU (or IAB node). Due the setup of the new SCTP association in advance, the IAB donor can associate the new SCTP session with an existing F1-C connection and in this way continue F1-AP signalling. In this manner, the IAB node is able to continue use of the F1-C signaling connection during relocation to a target path, making it possible for the IAB node to serve UEs during the IAB relocation.

One exemplary benefit and/or improvement is minimizing and/or reducing service interruption. Another exemplary benefit is that embodiments require only small modifications to existing F1 procedures, thereby facilitating rapid standardization and deployment in networks. Another exemplary benefit and/or improvement is reducing the need for UE-related signalling, which in turn can reduce UE and network power consumption and radio interference, while increasing system capacity.

A first group of embodiments are based on DU-initiated SCTP (or TNL) association setup. As discussed above in relation to FIGS. 19-20, a gNB-CU can use the gNB-CU Configuration Update message to add additional TNL associations and/or modify/release existing TNL associations. The message IEs relevant for this purpose include:
gNB-CU TNL Association To Add Item: for new TNL address to be added. This address doesn't need to be a new address since more than one association is possible with the same TNL address of the CU, so long as a different port number is used for each association.
gNB-CU TNL Association To Remove Item: for old TNL addresses to be removed.
gNB-CU TNL Association To Update Item: for old TNL addresses to be updated.
   These procedures are initiated from the CU based on the CU's need for more or fewer TNL associations (e.g., for load balancing). These exemplary embodiments reuse and augment this existing mechanism to handle the case of relocation of IAB node.

For example, an IAB node can be provided with a new TNL association from the IAB network, which can be used when the IAB node arrives in a target cell (e.g., served by a target node that is part of the target path) after relocation. In contrast, existing techniques require a gNB-DU to setup any new requested TNL from the CU immediately when it receives the gNB-CU Configuration Update message indicating gNB-CU TNL Association To Add.

Furthermore, when the IAB node connects to the target cell, it initiates a new SCTP Association (or TNL association) towards the TNL address provided from the CU. This operation can involve normal SCTP setup and can be performed using the New IAB node TNL address allocated as part of the relocation. In this manner, all signaling over the new SCTP association will be between the CU and IAB node using the new path established during the relocation.

In addition, when the donor-CU receives the SCTP setup request, it can associate this newly created SCTP association with the existing F1-C connection, thereby facilitating continued F1-AP signaling. During this process, the donor-CU can also determine which TNL address the IAB node is using for CP signaling after relocation. This knowledge can further be used for other functionality in the CU or over F1.

In some of these embodiments, the IAB node can also send an F1 message to the CU over the new SCTP connection which provides an indication (using, e.g., some address or identifier) associated with the previous F1-C connection as a way to confirm that the F1-C connection has been moved to the new SCTP association.

In some of these embodiments, the CU can also send an F1 message to the IAB node over the new SCTP connection which provides an indication (using, e.g., some address or identifier) associated with the previous F1-C connection as a way to confirm that the F1-C connection has been moved to the new SCTP association.

In some of these embodiments, after the F1-C connection has been relocated, the transmitting node (e.g., IAB node or donor-CU) may re-send some control messages (e.g., F1-AP or RRC) that may or may not have been delivered prior to the relocation. The transmitting node can use information from lower layers (e.g., SCTP acknowledgments) as an indication if the control message(s) were delivered or not. In case duplications are introduced due to this re-transmission, in some embodiments, the PDCP layer in the UE and/or the CU could remove a duplicated RRC message. In some embodiments, the transmitting node can selectively re-transmit messages such as, e.g., by not re-transmitting some specific F1 messages which are no longer expected to be valid or relevant in the target cell or target path.

In some of these embodiments, after the F1-C connection has been relocated to the new SCTP association, the CU and IAB node can discard any old SCTP association, either locally or based on exchanging messages over the new SCTP connection.

Within these embodiments, there are various options for how the relocating IAB node can be provided with the new TNL address of the CU to be used after the relocation. For instance, certain embodiments can include enhancements to the current F1 interface between the IAB node (i.e., DU part) and the CU. This can involve addition of new IEs in the gNB-DU Configuration Update message including, e.g., newTNLRe quest IE, newIPAddress IE, etc. These new IEs can inform the receiving CU that the sending DU requests a new TNL association to be initiated between the CU and the DU. The CU can then respond with a modified gNB-DU Configuration Update Acknowledgement message that indicates if it was possible to set up the new association.

As another option, new messages can be introduced to carry such new IEs. For example, gNB-DU CP TNL Relocation Request and gNB-DU CP TNL Relocation Request Acknowledge messages could be defined for such a purpose.

Other embodiments can utilize an enhanced F1 interface communication between the donor DU and CU for relocation of the tunnel end points between the IAB node (DU part) and the CU. For example, when the IP address of the IAB node changes (or a change is impending) due to relocation/handover to a new serving IAB node, this can trigger CU to provide the IAB node with a new TNL address to be used after the relocation.

In some of these embodiments, the donor DU can notify the donor CU about the IP address change, including the new and old IP addresses. This can be done as part of an enhanced gNB-DU Configuration Update message, or a new F1 message can be introduced for that purpose. When the donor CU receives the trigger notification, it will initiate a gNB-CU Configuration Update procedure (such as shown in FIG. 19) towards the IAB node to provide the IAB node with a new TNL association. Alternately, the donor CU can use a newly-defined message to provide the IAB node with the new TNL association.

When the DU part of the IAB node receives this message with the new TNL association, it can initiate a new SCTP association by using its new IP address and the TNL address provided by the gNB-CU (which can be the same as the old IP address that was used for the previous SCTP association).

In some embodiments, the CU could include a particular field in the gNB-CU Configuration Update (or newly defined) message, to indicate that the new TNL association is to be used for IAB node relocation, or that the IAB node should not establish the SCTP association until after relocation. For example, the CU can provide the IAB node with a new TNL association along with an indication that it is to be used after a future relocation, even if no relocation is prepared at the time the message was sent/received.

A second group of embodiments are based on CU-initiated SCTP (or TNL) association setup. For example, a CU can initiate a SCTP (or TNL) Association setup after the relocation towards the new TNL address of the IAB, which is associated with the new path to the IAB node. In this case the CU needs to be provided with the new TNL address of the IAB node DU, which can be done in different ways. In some embodiments, the DU could send a gNB-DU Configuration Update (or similar new) message to provide the CU with the new TNL address. In other embodiments, the CU could be provided the new TNL address by the target DU or donor DU. When the relocation of the IAB node is complete, the CU can initiate the SCTP association using the new TNL address. The IAB node will associate this TNL association with the existing F1-C connection, thereby facilitating the continuation of F1-AP signalling.

This second group of embodiments also includes variations and/or options similar to those discussed above with respect to the first group of embodiments. These variations and/or options include but are not limited to:
F1 Confirmation messages exchanged in either direction, confirming the transfer of the F1-C connection to the new TNL association;
CU and/or IAB node removing the old TNL association;
Forwarding of messages undelivered on the old association to the new association;
Triggering the setup of TNL association or allocation of TNL address based on parts of the relocation procedure e.g. preparation signaling;
Providing the TNL address in advance of the relocation to be used at the next relocation;
Including a special indication or flag that the TNL address is to be used at relocation.

A third group of embodiments is based on implicit handling of the relocation, e.g., where no explicit gNB-CU or gNB-DU initiated F1-AP level signaling is provided for the TNL relocation. In such embodiments, the gNB-CU is in control of the new IP address assignment, or at least can made aware of the new IP addresses that are going to be used by the IAB node after relocation. Once the IAB node has relocated to the target cell and acquired new IP address(es), it can trigger the SCTP initiation. Since the gNB-CU is aware of these IP addresses, when it receives an SCTP initiation request from these IP addresses, it initiates relocation of the TNL association and performs the switching of the old F1-AP tunnel to the new one. In this manner, no F1-AP signaling is required and both the IAB-node and the gNB-DU will perform the switching of the TNL association implicitly.

A fourth group of embodiments comprise techniques that are applicable to CP TNL address relocation in non-IAB networks. For example, a DU could have several logical units that could employ different IP addresses, and the DU can switch off and on these unites as needed for reasons such as power saving, load balancing, maintenance, etc. If that happens, the same mechanisms above could be reused to communicate the change of the IP address and thereby trigger the tunnel remapping.

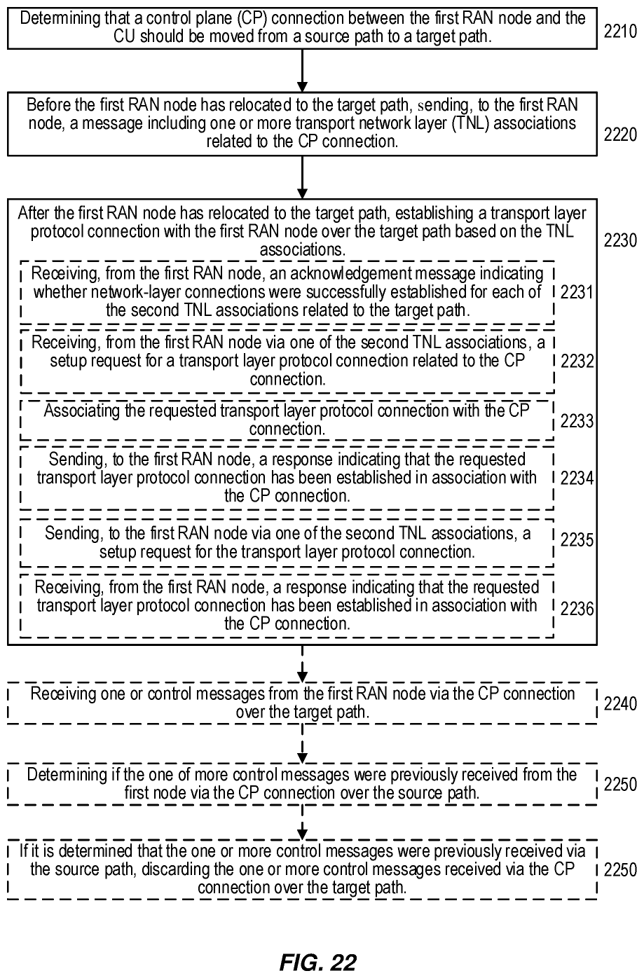

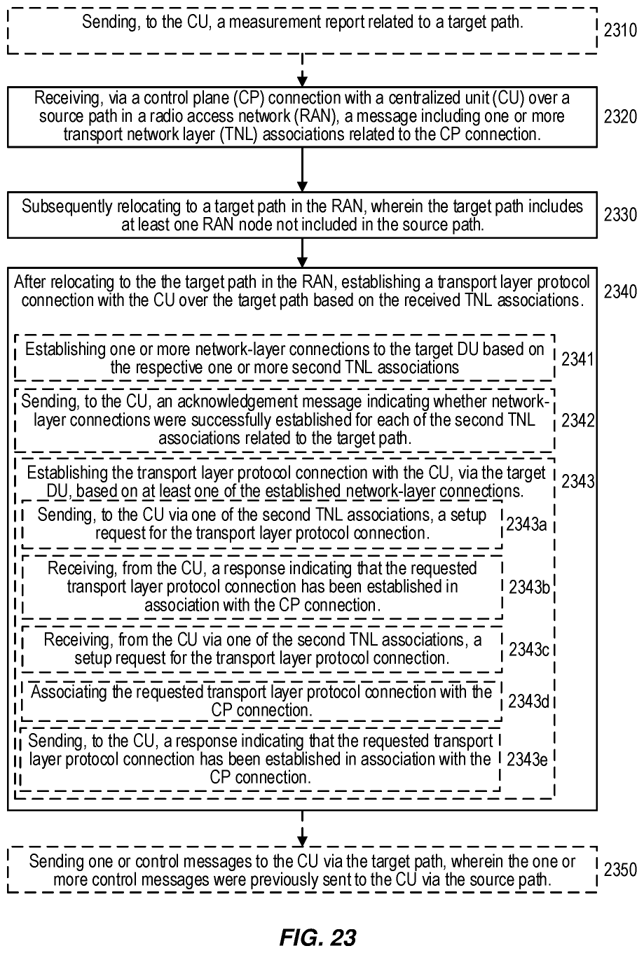

The embodiments described above are further illustrated by FIGS. 22-23, which show flow diagrams of exemplary methods performed by a CU and a first radio access node (e.g., an IAB node comprising DU and MT parts), respectively. Put another way, various embodiments discussed above are represented as features and/or operations shown in FIGS. 22-23.

More specifically, FIG. 22 illustrates an exemplary method (e.g., procedure) performed by a centralized unit (CU) in a radio access network (RAN) comprising a first radio access node and a plurality of further radio access nodes, in accordance with various embodiments of the present disclosure. For example, the RAN can be an IAB network and at least some of the radio access nodes can be IAB nodes. The exemplary method shown in FIG. 22 can be complementary to other exemplary methods disclosed herein (e.g., FIG. 23), such that they can be used cooperatively to provide the benefits, advantages, and/or solutions to problems described herein. Although the exemplary method is illustrated in FIG. 22 by blocks in a particular order, this order is exemplary and the operations corresponding to the blocks can be performed in different orders than shown, and can be combined and/or divided into blocks having different functionality than shown. Optional operations are indicated by dashed lines.

The exemplary method shown in FIG. 22 can include the operations of block 2210, where the CU can determine that a control plane (CP) connection between a first radio access node and the CU should be moved from a source path in the RAN to a target path in the RAN. The target path can include at least one radio access node not included in the source path. For example, the source path can include a first subset of the further radio access nodes and a source distributed unit (DU) connected to the CU, while the target path can include a second subset of the further radio access nodes and a target DU connected to the CU. In some embodiments, the first radio access node can include a first mobile terminal and a first DU, and the CP connection can be an F1-C connection between the CU and the first DU.

In some embodiments, determining that the CP connection between the CU and the first radio access node should be moved can be based on any of the following: a measurement report, from the first radio access node, indicating that relocation to the target path is needed; from a target distributed unit, DU, connected to the CU and included in the target path, an indication that the first radio access node will be relocated to the target path; and a message, from the target DU, including the first TNL associations to be removed and the second TNL associations to be added.

The exemplary method can also include the operations of block 2220, where the CU can, based on determining (e.g., in block 2210) that the CP connection between the CU and the first radio access node should be moved, send to the first radio access node a message including one or more transport network layer (TNL) associations related to the CP connection. This message can be sent (e.g., via the source path) before the first radio access node has relocated to the target path. In some embodiments, each TNL association can include a tunnel endpoint identifier (TEID) and an Internet Protocol (IP) address. In some embodiments, the one or more TNL associations in the message can include one or more first TNL associations, related to the source path, to be removed; and one or more second TNL associations, related to the target path, to be added. In some embodiments, the message can also indicate that the second TNL associations are related to a relocation of the first radio access node from the source path to the target path.

The exemplary method can also include the operations of block 2230, where the CU can establish a transport layer protocol connection with the first radio access node over the target path based on the TNL associations. This operation can be performed after the first radio access node has relocated to the target path. In some embodiments, the transport layer protocol connection can be a Stream Control Transmission Protocol (SCTP) association, such as described above.

In some embodiments, the operations of block 2230 can include the operations of sub-block 2231, where the CU can receive, from the first radio access node, an acknowledgement message indicating whether network-layer connections were successfully established for each of the second TNL associations.

In some embodiments, the operations of block 2230 can include the operations of sub-block 2232-2234. In sub-block 2232, the CU can receive, from the first radio access node via one of the second TNL associations, a setup request for the transport layer protocol connection (e.g., an SCTP association). This setup request can be received after the first radio access node has relocated to the target path. In sub-block 2233, the CU can associate the requested transport layer protocol connection with the CP connection. In sub-block 2234, the CU can send, to the first radio access node, a response indicating that the requested transport layer protocol connection has been established in association with the CP connection. These operations can correspond, for example, to a DU-initiated procedure.

In other embodiments, the operations of block 2230 can include the operations of sub-block 2235-2236. In sub-block 2235, the CU can send, to the first radio access node via one of the second TNL associations, a setup request for the transport layer protocol connection. This setup request can be sent after the first radio access node has relocated to the target path. In sub-block 2236, the CU can receive, from the first radio access node, a response indicating that the requested transport layer protocol connection has been established in association with the CP connection. These operations can correspond, for example, to a CU-initiated procedure.

In some embodiments, the exemplary method can also include the operations of block 2240-2260. In block 2240, the CU can receive one or control messages from the first radio access node via the CP connection over the target path. In block 2250, the CU can determine if the one of more control messages were previously received from the first radio access node via the CP connection over the source path. If it is determined that the one of more control messages were previously received via the CP connection over the source path, in block 2260, the CU can discard the one or more control messages received via the CP connection over the target path.

In addition, FIG. 23 illustrates another exemplary method (e.g., procedure) performed by a first radio access node in a RAN that includes a CU and a plurality of further radio access nodes, in accordance with various embodiments of the present disclosure. For example, the RAN can be an IAB network and the first radio access node can be an IAB node. The exemplary method shown in FIG. 23 can be complementary to other exemplary methods disclosed herein (e.g., FIG. 22), such that they can be used cooperatively to provide the benefits, advantages, and/or solutions to problems described herein. Although the exemplary method is illustrated in FIG. 23 by blocks in a particular order, this order is exemplary and the operations corresponding to the blocks can be performed in different orders than shown, and can be combined and/or divided into blocks having different functionality than shown. Optional operations are indicated by dashed lines.

In some embodiments, the exemplary method shown in FIG. 23 can include the operations of block 2310, where the first radio access node can send, to the CU, a measurement report related to a target path in the RAN. The measurements can be sent via a source path in the RAN. The exemplary method can also include the operations of block 2320, where the first radio access node can receive, via a control plane (CP) connection with the CU, a message including one or more transport network layer (TNL) associations related to the CP connection. The message can be received via a source path in the RAN and, in some embodiments, can be responsive to the measurements sent in block 2310.

The target path can include at least one radio access node not included in the source path. For example, the source path can include a first subset of the further radio access nodes and a source distributed unit (DU) connected to the CU, while the target path can include a second subset of the further radio access nodes and a target DU connected to the CU. In some embodiments, the first radio access node can include a first mobile terminal and a first DU, and the CP connection can be an F1-C connection between the CU and the first DU.

In some embodiments, each TNL association can include a tunnel endpoint identifier (TEID) and an Internet Protocol (IP) address. In some embodiments, the one or more TNL associations in the message can include one or more first TNL associations, related to the source path, to be removed; and one or more second TNL associations, related to the target path, to be added. In some embodiments, the message can also indicate that the second TNL associations are related to a relocation of the first radio access node from the source path to the target path.

The exemplary method can also include the operations of block 2330, where the first radio access node can subsequently (e.g., after receiving the message in block 2320) relocate to the target path in the RAN. The exemplary method can also include the operations of block 2340, where the first radio access node can establish a transport layer protocol connection with the CU over the target path based on the received TNL associations. The transport layer protocol connection can be established after first radio access node relocates to the target path. In some embodiments, the transport layer protocol connection can be a SCTP association, such as described above.

In some embodiments, the operations of block 2340 can include the operations of sub-blocks 2341 and 2343. In sub-block 2341, the first radio access node can establish one or more network-layer connections to the target DU based on the respective one or more second TNL associations. In sub-block 2343, the first radio access node can establish the transport layer protocol connection with the CU, via the target DU, based on at least one of the established network-layer connections. In some embodiments, the operations of block 2340 can include the operations of sub-block 2342, where the first radio access node can send, to the CU, an acknowledgement message indicating whether network-layer connections were successfully established for each of the second TNL associations. For example, the operations in sub-block 2342 can be responsive to the operations in sub-block 2341.

In some embodiments, the operations of sub-block 2343 can include the operations of sub-blocks 2343a-b. In sub-block 2343a, the first radio access node can send, to the CU via one of the second TNL associations, a setup request for the transport layer protocol connection. In sub-block 2343a, the first radio access node can receive, from the CU, a response indicating that the requested transport layer protocol connection has been established in association with the CP connection. These operations can correspond, for example, to a DU-initiated procedure.

In other embodiments, the operations of sub-block 2343 can include the operations of sub-blocks 2343c-e. In sub-block 2343c, the first radio access node can receive, from the CU via one of the second TNL associations, a setup request for the transport layer protocol connection. In sub-block 2343d, the first radio access node can associate the requested transport layer protocol connection with the CP connection. In sub-block 2343e, the first radio access node can send, to the CU, a response indicating that the requested transport layer protocol connection has been established in association with the CP connection. These operations can correspond, for example, to a CU-initiated procedure.

In some embodiments, the exemplary method can include the operations of block 2350, where the first radio access node can send one or control messages to the CU via the CP connection over the target path. In such embodiments, the one or more control messages were previously sent to the CU via the CP connection over the source path. This operation can correspond to the operations shown in blocks 2240-2260 of FIG. 22, described above.

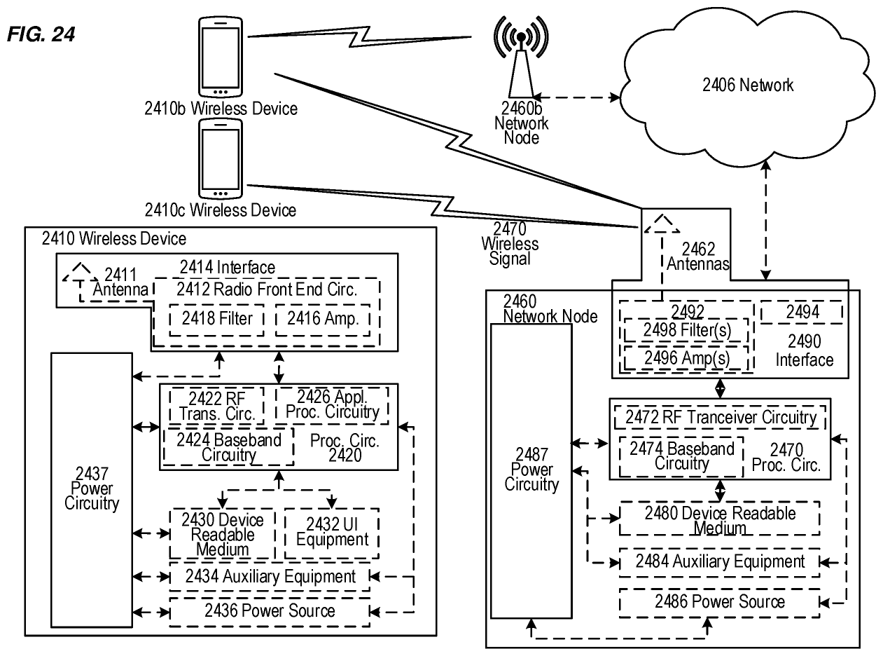

Although the subject matter described herein can be implemented in any appropriate type of system using any suitable components, the embodiments disclosed herein are described in relation to a wireless network, such as the example wireless network illustrated in FIG. 24. For simplicity, the wireless network of FIG. 24 only depicts network 2406, network nodes 2460 and 2460b, and WDs 2410, 2410b, and 2410c. In practice, a wireless network can further include any additional elements suitable to support communication between wireless devices or between a wireless device and another communication device, such as a landline telephone, a service provider, or any other network node or end device. Of the illustrated components, network node 2460 and wireless device (WD) 2410 are depicted with additional detail. The wireless network can provide communication and other types of services to one or more wireless devices to facilitate the wireless devices' access to and/or use of the services provided by, or via, the wireless network.

The wireless network can comprise and/or interface with any type of communication, telecommunication, data, cellular, and/or radio network or other similar type of system. In some embodiments, the wireless network can be configured to operate according to specific standards or other types of predefined rules or procedures. Thus, particular embodiments of the wireless network can implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 2406 can comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 2460 and WD 2410 comprise various components described in more detail below. These components work together in order to provide network node and/or wireless device functionality, such as providing wireless connections in a wireless network. In different embodiments, the wireless network can comprise any number of wired or wireless networks, network nodes, base stations, controllers, wireless devices, relay stations, and/or any other components or systems that can facilitate or participate in the communication of data and/or signals whether via wired or wireless connections.

Examples of network nodes include, but are not limited to, access points (APs) (e.g., radio access points), base stations (BSs) (e.g., radio base stations, NBs, eNBs, gNBs, or components thereof). Base stations can be categorized based on the amount of coverage they provide (or, stated differently, their transmit power level) and can then also be referred to as femto base stations, pico base stations, micro base stations, or macro base stations. A base station can be a relay node or a relay donor node controlling a relay. A network node can also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station can also be referred to as nodes in a distributed antenna system (DAS).

Further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node can be a virtual network node as described in more detail below.

In FIG. 24, network node 2460 includes processing circuitry 2470, device readable medium 2480, interface 2490, auxiliary equipment 2484, power source 2486, power circuitry 2487, and antenna 2462. Although network node 2460 illustrated in the example wireless network of FIG. 24 can represent a device that includes the illustrated combination of hardware components, other embodiments can comprise network nodes with different combinations of components. It is to be understood that a network node comprises any suitable combination of hardware and/or software needed to perform the tasks, features, functions and methods and/or procedures disclosed herein. Moreover, while the components of network node 2460 are depicted as single boxes located within a larger box, or nested within multiple boxes, in practice, a network node can comprise multiple different physical components that make up a single illustrated component (e.g., device readable medium 2480 can comprise multiple separate hard drives as well as multiple RAM modules).

Similarly, network node 2460 can be composed of multiple physically separate components (e.g., a NodeB component and a RNC component, or a BTS component and a BSC component, etc.), which can each have their own respective components. In certain scenarios in which network node 2460 comprises multiple separate components (e.g., BTS and BSC components), one or more of the separate components can be shared among several network nodes. For example, a single RNC can control multiple NodeB's. In such a scenario, each unique NodeB and RNC pair, can in some instances be considered a single separate network node. In some embodiments, network node 2460 can be configured to support multiple radio access technologies (RATs). In such embodiments, some components can be duplicated (e.g., separate device readable medium 2480 for the different RATs) and some components can be reused (e.g., the same antenna 2462 can be shared by the RATs). Network node 2460 can also include multiple sets of the various illustrated components for different wireless technologies integrated into network node 2460, such as, for example, GSM, WCDMA, LTE, NR, WiFi, or Bluetooth wireless technologies. These wireless technologies can be integrated into the same or different chip or set of chips and other components within network node 2460.

Processing circuitry 2470 can be configured to perform any determining, calculating, or similar operations (e.g., certain obtaining operations) described herein as being provided by a network node. These operations performed by processing circuitry 2470 can include processing information obtained by processing circuitry 2470 by, for example, converting the obtained information into other information, comparing the obtained information or converted information to information stored in the network node, and/or performing one or more operations based on the obtained information or converted information, and as a result of said processing making a determination.

Processing circuitry 2470 can comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2460 components, such as device readable medium 2480, network node 2460 functionality. For example, processing circuitry 2470 can execute instructions stored in device readable medium 2480 or in memory within processing circuitry 2470. Such functionality can include providing any of the various wireless features, functions, or benefits discussed herein. In some embodiments, processing circuitry 2470 can include a system on a chip (SOC).

In some embodiments, processing circuitry 2470 can include one or more of radio frequency (RF) transceiver circuitry 2472 and baseband processing circuitry 2474. In some embodiments, radio frequency (RF) transceiver circuitry 2472 and baseband processing circuitry 2474 can be on separate chips (or sets of chips), boards, or units, such as radio units and digital units. In alternative embodiments, part or all of RF transceiver circuitry 2472 and baseband processing circuitry 2474 can be on the same chip or set of chips, boards, or units

In certain embodiments, some or all of the functionality described herein as being provided by a network node, base station, eNB or other such network device can be performed by processing circuitry 2470 executing instructions stored on device readable medium 2480 or memory within processing circuitry 2470. In alternative embodiments, some or all of the functionality can be provided by processing circuitry 2470 without executing instructions stored on a separate or discrete device readable medium, such as in a hard-wired manner In any of those embodiments, whether executing instructions stored on a device readable storage medium or not, processing circuitry 2470 can be configured to perform the described functionality. The benefits provided by such functionality are not limited to processing circuitry 2470 alone or to other components of network node 2460, but are enjoyed by network node 2460 as a whole, and/or by end users and the wireless network generally.

Device readable medium 2480 can comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that can be used by processing circuitry 2470. Device readable medium 2480 can store any suitable instructions, data or information, including a computer program, software, an application including one or more of logic, rules, code, tables, etc. and/or other instructions capable of being executed by processing circuitry 2470 and, utilized by network node 2460. Device readable medium 2480 can be used to store any calculations made by processing circuitry 2470 and/or any data received via interface 2490. In some embodiments, processing circuitry 2470 and device readable medium 2480 can be considered to be integrated.

Interface 2490 is used in the wired or wireless communication of signalling and/or data between network node 2460, network 2406, and/or WDs 2410. As illustrated, interface 2490 comprises port(s)/terminal(s) 2494 to send and receive data, for example to and from network 2406 over a wired connection. Interface 2490 also includes radio front end circuitry 2492 that can be coupled to, or in certain embodiments a part of, antenna 2462. Radio front end circuitry 2492 comprises filters 2498 and amplifiers 2496. Radio front end circuitry 2492 can be connected to antenna 2462 and processing circuitry 2470. Radio front end circuitry can be configured to condition signals communicated between antenna 2462 and processing circuitry 2470. Radio front end circuitry 2492 can receive digital data that is to be sent out to other network nodes or WDs via a wireless connection. Radio front end circuitry 2492 can convert the digital data into a radio signal having the appropriate channel and bandwidth parameters using a combination of filters 2498 and/or amplifiers 2496. The radio signal can then be transmitted via antenna 2462. Similarly, when receiving data, antenna 2462 can collect radio signals which are then converted into digital data by radio front end circuitry 2492. The digital data can be passed to processing circuitry 2470. In other embodiments, the interface can comprise different components and/or different combinations of components.

In certain alternative embodiments, network node 2460 may not include separate radio front end circuitry 2492, instead, processing circuitry 2470 can comprise radio front end circuitry and can be connected to antenna 2462 without separate radio front end circuitry 2492. Similarly, in some embodiments, all or some of RF transceiver circuitry 2472 can be considered a part of interface 2490. In still other embodiments, interface 2490 can include one or more ports or terminals 2494, radio front end circuitry 2492, and RF transceiver circuitry 2472, as part of a radio unit (not shown), and interface 2490 can communicate with baseband processing circuitry 2474, which is part of a digital unit (not shown).

Antenna 2462 can include one or more antennas, or antenna arrays, configured to send and/or receive wireless signals. Antenna 2462 can be coupled to radio front end circuitry 2490 and can be any type of antenna capable of transmitting and receiving data and/or signals wirelessly. In some embodiments, antenna 2462 can comprise one or more omni-directional, sector or panel antennas operable to transmit/receive radio signals between, for example, 2 GHz and 66 GHz. An omni-directional antenna can be used to transmit/receive radio signals in any direction, a sector antenna can be used to transmit/receive radio signals from devices within a particular area, and a panel antenna can be a line of sight antenna used to transmit/receive radio signals in a relatively straight line. In some instances, the use of more than one antenna can be referred to as MIMO. In certain embodiments, antenna 2462 can be separate from network node 2460 and can be connectable to network node 2460 through an interface or port.

Antenna 2462, interface 2490, and/or processing circuitry 2470 can be configured to perform any receiving operations and/or certain obtaining operations described herein as being performed by a network node. Any information, data and/or signals can be received from a wireless device, another network node and/or any other network equipment. Similarly, antenna 2462, interface 2490, and/or processing circuitry 2470 can be configured to perform any transmitting operations described herein as being performed by a network node. Any information, data and/or signals can be transmitted to a wireless device, another network node and/or any other network equipment.

Power circuitry 2487 can comprise, or be coupled to, power management circuitry and can be configured to supply the components of network node 2460 with power for performing the functionality described herein. Power circuitry 2487 can receive power from power source 2486. Power source 2486 and/or power circuitry 2487 can be configured to provide power to the various components of network node 2460 in a form suitable for the respective components (e.g., at a voltage and current level needed for each respective component). Power source 2486 can either be included in, or external to, power circuitry 2487 and/or network node 2460. For example, network node 2460 can be connectable to an external power source (e.g., an electricity outlet) via an input circuitry or interface such as an electrical cable, whereby the external power source supplies power to power circuitry 2487. As a further example, power source 2486 can comprise a source of power in the form of a battery or battery pack which is connected to, or integrated in, power circuitry 2487. The battery can provide backup power should the external power source fail. Other types of power sources, such as photovoltaic devices, can also be used.

Alternative embodiments of network node 2460 can include additional components beyond those shown in FIG. 24 that can be responsible for providing certain aspects of the network node's functionality, including any of the functionality described herein and/or any functionality necessary to support the subject matter described herein. For example, network node 2460 can include user interface equipment to allow and/or facilitate input of information into network node 2460 and to allow and/or facilitate output of information from network node 2460. This can allow and/or facilitate a user to perform diagnostic, maintenance, repair, and other administrative functions for network node 2460.

In some embodiments, a wireless device (WD, e.g., WD 2410 can be configured to transmit and/or receive information without direct human interaction. For instance, a WD can be designed to transmit information to a network on a predetermined schedule, when triggered by an internal or external event, or in response to requests from the network. Examples of a WD include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.

A WD can support device-to-device (D2D) communication, for example by implementing a 3GPP standard for sidelink communication, vehicle-to-vehicle (V2V), vehicle-to-infrastructure (V2I), vehicle-to-everything (V2X) and can in this case be referred to as a D2D communication device. As yet another specific example, in an Internet of Things (IoT) scenario, a WD can represent a machine or other device that performs monitoring and/or measurements, and transmits the results of such monitoring and/or measurements to another WD and/or a network node. The WD can in this case be a machine-to-machine (M2M) device, which can in a 3GPP context be referred to as an MTC device. As one particular example, the WD can be a UE implementing the 3GPP narrow band internet of things (NB-IoT) standard. Particular examples of such machines or devices are sensors, metering devices such as power meters, industrial machinery, or home or personal appliances (e.g.,refrigerators, televisions, etc.) personal wearables (e.g., watches, fitness trackers, etc.). In other scenarios, a WD can represent a vehicle or other equipment that is capable of monitoring and/or reporting on its operational status or other functions associated with its operation. A WD as described above can represent the endpoint of a wireless connection, in which case the device can be referred to as a wireless terminal. Furthermore, a WD as described above can be mobile, in which case it can also be referred to as a mobile device or a mobile terminal.

As illustrated, wireless device 2410 includes antenna 2411, interface 2414, processing circuitry 2420, device readable medium 2430, user interface equipment 2432, auxiliary equipment 2434, power source 2436 and power circuitry 2437. WD 2410 can include multiple sets of one or more of the illustrated components for different wireless technologies supported by WD 2410, such as, for example, GSM, WCDMA, LTE, NR, WiFi, WiMAX, or Bluetooth wireless technologies, just to mention a few. These wireless technologies can be integrated into the same or different chips or set of chips as other components within WD 2410.

Antenna 2411 can include one or more antennas or antenna arrays, configured to send and/or receive wireless signals, and is connected to interface 2414. In certain alternative embodiments, antenna 2411 can be separate from WD 2410 and be connectable to WD 2410 through an interface or port. Antenna 2411, interface 2414, and/or processing circuitry 2420 can be configured to perform any receiving or transmitting operations described herein as being performed by a WD. Any information, data and/or signals can be received from a network node and/or another WD. In some embodiments, radio front end circuitry and/or antenna 2411 can be considered an interface.

As illustrated, interface 2414 comprises radio front end circuitry 2412 and antenna 2411. Radio front end circuitry 2412 comprise one or more filters 2418 and amplifiers 2416. Radio front end circuitry 2414 is connected to antenna 2411 and processing circuitry 2420, and can be configured to condition signals communicated between antenna 2411 and processing circuitry 2420. Radio front end circuitry 2412 can be coupled to or a part of antenna 2411. In some embodiments, WD 2410 may not include separate radio front end circuitry 2412; rather, processing circuitry 2420 can comprise radio front end circuitry and can be connected to antenna 2411. Similarly, in some embodiments, some or all of RF transceiver circuitry 2422 can be considered a part of interface 2414. Radio front end circuitry 2412 can receive digital data that is to be sent out to other network nodes or WDs via a wireless connection. Radio front end circuitry 2412 can convert the digital data into a radio signal having the appropriate channel and bandwidth parameters using a combination of filters 2418 and/or amplifiers 2416. The radio signal can then be transmitted via antenna 2411. Similarly, when receiving data, antenna 2411 can collect radio signals which are then converted into digital data by radio front end circuitry 2412. The digital data can be passed to processing circuitry 2420. In other embodiments, the interface can comprise different components and/or different combinations of components.

Processing circuitry 2420 can comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 2410 components, such as device readable medium 2430, WD 2410 functionality. Such functionality can include providing any of the various wireless features or benefits discussed herein. For example, processing circuitry 2420 can execute instructions stored in device readable medium 2430 or in memory within processing circuitry 2420 to provide the functionality disclosed herein.

As illustrated, processing circuitry 2420 includes one or more of RF transceiver circuitry 2422, baseband processing circuitry 2424, and application processing circuitry 2426. In other embodiments, the processing circuitry can comprise different components and/or different combinations of components. In certain embodiments processing circuitry 2420 of WD 2410 can comprise a SOC. In some embodiments, RF transceiver circuitry 2422, baseband processing circuitry 2424, and application processing circuitry 2426 can be on separate chips or sets of chips. In alternative embodiments, part or all of baseband processing circuitry 2424 and application processing circuitry 2426 can be combined into one chip or set of chips, and RF transceiver circuitry 2422 can be on a separate chip or set of chips. In still alternative embodiments, part or all of RF transceiver circuitry 2422 and baseband processing circuitry 2424 can be on the same chip or set of chips, and application processing circuitry 2426 can be on a separate chip or set of chips. In yet other alternative embodiments, part or all of RF transceiver circuitry 2422, baseband processing circuitry 2424, and application processing circuitry 2426 can be combined in the same chip or set of chips. In some embodiments, RF transceiver circuitry 2422 can be a part of interface 2414. RF transceiver circuitry 2422 can condition RF signals for processing circuitry 2420.

In certain embodiments, some or all of the functionality described herein as being performed by a WD can be provided by processing circuitry 2420 executing instructions stored on device readable medium 2430, which in certain embodiments can be a computer-readable storage medium. In alternative embodiments, some or all of the functionality can be provided by processing circuitry 2420 without executing instructions stored on a separate or discrete device readable storage medium, such as in a hard-wired manner In any of those particular embodiments, whether executing instructions stored on a device readable storage medium or not, processing circuitry 2420 can be configured to perform the described functionality. The benefits provided by such functionality are not limited to processing circuitry 2420 alone or to other components of WD 2410, but are enjoyed by WD 2410 as a whole, and/or by end users and the wireless network generally.

Processing circuitry 2420 can be configured to perform any determining, calculating, or similar operations (e.g., certain obtaining operations) described herein as being performed by a WD. These operations, as performed by processing circuitry 2420, can include processing information obtained by processing circuitry 2420 by, for example, converting the obtained information into other information, comparing the obtained information or converted information to information stored by WD 2410, and/or performing one or more operations based on the obtained information or converted information, and as a result of said processing making a determination.

Device readable medium 2430 can be operable to store a computer program, software, an application including one or more of logic, rules, code, tables, etc. and/or other instructions capable of being executed by processing circuitry 2420. Device readable medium 2430 can include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that can be used by processing circuitry 2420. In some embodiments, processing circuitry 2420 and device readable medium 2430 can be considered to be integrated.

User interface equipment 2432 can include components that allow and/or facilitate a human user to interact with WD 2410. Such interaction can be of many forms, such as visual, audial, tactile, etc. User interface equipment 2432 can be operable to produce output to the user and to allow and/or facilitate the user to provide input to WD 2410. The type of interaction can vary depending on the type of user interface equipment 2432 installed in WD 2410. For example, if WD 2410 is a smart phone, the interaction can be via a touch screen; if WD 2410 is a smart meter, the interaction can be through a screen that provides usage (e.g., the number of gallons used) or a speaker that provides an audible alert (e.g., if smoke is detected). User interface equipment 2432 can include input interfaces, devices and circuits, and output interfaces, devices and circuits. User interface equipment 2432 can be configured to allow and/or facilitate input of information into WD 2410, and is connected to processing circuitry 2420 to allow and/or facilitate processing circuitry 2420 to process the input information. User interface equipment 2432 can include, for example, a microphone, a proximity or other sensor, keys/buttons, a touch display, one or more cameras, a USB port, or other input circuitry. User interface equipment 2432 is also configured to allow and/or facilitate output of information from WD 2410, and to allow and/or facilitate processing circuitry 2420 to output information from WD 2410. User interface equipment 2432 can include, for example, a speaker, a display, vibrating circuitry, a USB port, a headphone interface, or other output circuitry. Using one or more input and output interfaces, devices, and circuits, of user interface equipment 2432, WD 2410 can communicate with end users and/or the wireless network, and allow and/or facilitate them to benefit from the functionality described herein.

Auxiliary equipment 2434 is operable to provide more specific functionality which may not be generally performed by WDs. This can comprise specialized sensors for doing measurements for various purposes, interfaces for additional types of communication such as wired communications etc. The inclusion and type of components of auxiliary equipment 2434 can vary depending on the embodiment and/or scenario.

Power source 2436 can, in some embodiments, be in the form of a battery or battery pack. Other types of power sources, such as an external power source (e.g., an electricity outlet), photovoltaic devices or power cells, can also be used. WD 2410 can further comprise power circuitry 2437 for delivering power from power source 2436 to the various parts of WD 2410 which need power from power source 2436 to carry out any functionality described or indicated herein. Power circuitry 2437 can in certain embodiments comprise power management circuitry. Power circuitry 2437 can additionally or alternatively be operable to receive power from an external power source; in which case WD 2410 can be connectable to the external power source (such as an electricity outlet) via input circuitry or an interface such as an electrical power cable. Power circuitry 2437 can also in certain embodiments be operable to deliver power from an external power source to power source 2436. This can be, for example, for the charging of power source 2436. Power circuitry 2437 can perform any converting or other modification to the power from power source 2436 to make it suitable for supply to the respective components of WD 2410.

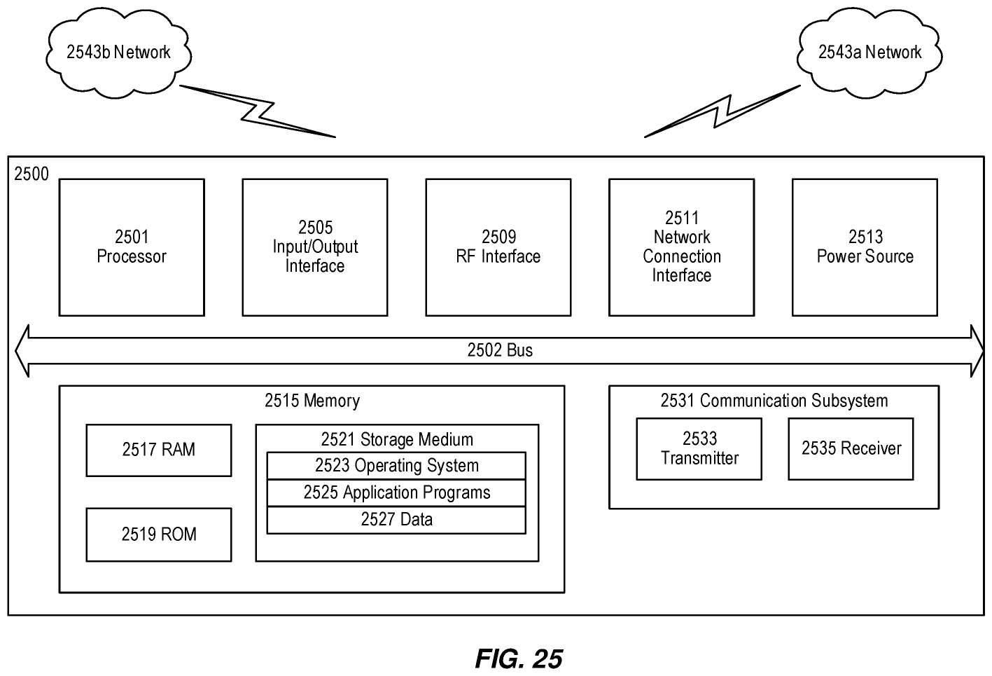

FIG. 25 illustrates one embodiment of a UE in accordance with various aspects described herein. As used herein, a user equipment or UE may not necessarily have a user in the sense of a human user who owns and/or operates the relevant device. Instead, a UE can represent a device that is intended for sale to, or operation by, a human user but which may not, or which may not initially, be associated with a specific human user (e.g., a smart sprinkler controller). Alternatively, a UE can represent a device that is not intended for sale to, or operation by, an end user but which can be associated with or operated for the benefit of a user (e.g., a smart power meter). UE 25200 can be any UE identified by the 3^{rd} Generation Partnership Project (3GPP), including a NB-IoT UE, a machine type communication (MTC) UE, and/or an enhanced MTC (eMTC) UE. UE 2500, as illustrated in FIG. 25, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE can be used interchangeable. Accordingly, although FIG. 25 is a UE, the components discussed herein are equally applicable to a WD, and vice-versa.

In FIG. 25, UE 2500 includes processing circuitry 2501 that is operatively coupled to input/output interface 2505, radio frequency (RF) interface 2509, network connection interface 2511, memory 2515 including random access memory (RAM) 2517, read-only memory (ROM) 2519, and storage medium 2521 or the like, communication subsystem 2531, power source 2533, and/or any other component, or any combination thereof. Storage medium 2521 includes operating system 2523, application program 2525, and data 2527. In other embodiments, storage medium 2521 can include other similar types of information. Certain UEs can utilize all of the components shown in FIG. 25, or only a subset of the components. The level of integration between the components can vary from one UE to another UE. Further, certain UEs can contain multiple instances of a component, such as multiple processors, memories, transceivers, transmitters, receivers, etc.

In FIG. 25, processing circuitry 2501 can be configured to process computer instructions and data. Processing circuitry 2501 can be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 2501 can include two central processing units (CPUs). Data can be information in a form suitable for use by a computer.

In the depicted embodiment, input/output interface 2505 can be configured to provide a communication interface to an input device, output device, or input and output device. UE 2500 can be configured to use an output device via input/output interface 2505. An output device can use the same type of interface port as an input device. For example, a USB port can be used to provide input to and output from UE 2500. The output device can be a speaker, a sound card, a video card, a display, a monitor, a printer, an actuator, an emitter, a smartcard, another output device, or any combination thereof. UE 2500 can be configured to use an input device via input/output interface 2505 to allow and/or facilitate a user to capture information into UE 2500. The input device can include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display can include a capacitive or resistive touch sensor to sense input from a user. A sensor can be, for instance, an accelerometer, a gyroscope, a tilt sensor, a force sensor, a magnetometer, an optical sensor, a proximity sensor, another like sensor, or any combination thereof. For example, the input device can be an accelerometer, a magnetometer, a digital camera, a microphone, and an optical sensor.

In FIG. 25, RF interface 2509 can be configured to provide a communication interface to RF components such as a transmitter, a receiver, and an antenna. Network connection interface 2511 can be configured to provide a communication interface to network 2543a. Network 2543a can encompass wired and/or wireless networks such as a local-area network (LAN), a wide-area network (WAN), a computer network, a wireless network, a telecommunications network, another like network or any combination thereof. For example, network 2543a can comprise a Wi-Fi network. Network connection interface 2511 can be configured to include a receiver and a transmitter interface used to communicate with one or more other devices over a communication network according to one or more communication protocols, such as Ethernet, TCP/IP, SONET, ATM, or the like. Network connection interface 2511 can implement receiver and transmitter functionality appropriate to the communication network links (e.g., optical, electrical, and the like). The transmitter and receiver functions can share circuit components, software or firmware, or alternatively can be implemented separately.

RAM 2517 can be configured to interface via bus 2502 to processing circuitry 2501 to provide storage or caching of data or computer instructions during the execution of software programs such as the operating system, application programs, and device drivers. ROM 2519 can be configured to provide computer instructions or data to processing circuitry 2501. For example, ROM 2519 can be configured to store invariant low-level system code or data for basic system functions such as basic input and output (I/O), startup, or reception of keystrokes from a keyboard that are stored in a non-volatile memory. Storage medium 2521 can be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 2521 can be configured to include operating system 2523, application program 2525 such as a web browser application, a widget or gadget engine or another application, and data file 2527. Storage medium 2521 can store, for use by UE 2500, any of a variety of various operating systems or combinations of operating systems.

Storage medium 2521 can be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 2521 can allow and/or facilitate UE 2500 to access computer-executable instructions, application programs or the like, stored on transitory or non-transitory memory media, to off-load data, or to upload data. An article of manufacture, such as one utilizing a communication system can be tangibly embodied in storage medium 2521, which can comprise a device readable medium.

In FIG. 25, processing circuitry 2501 can be configured to communicate with network 2543b using communication subsystem 2531. Network 2543a and network 2543b can be the same network or networks or different network or networks. Communication subsystem 2531 can be configured to include one or more transceivers used to communicate with network 2543b. For example, communication subsystem 2531 can be configured to include one or more transceivers used to communicate with one or more remote transceivers of another device capable of wireless communication such as another WD, UE, or base station of a radio access network (RAN) according to one or more communication protocols, such as IEEE 802.25, CDMA, WCDMA, GSM, LTE, UTRAN, WiMax, or the like. Each transceiver can include transmitter 2533 and/or receiver 2535 to implement transmitter or receiver functionality, respectively, appropriate to the RAN links (e.g., frequency allocations and the like). Further, transmitter 2533 and receiver 2535 of each transceiver can share circuit components, software or firmware, or alternatively can be implemented separately.

In the illustrated embodiment, the communication functions of communication subsystem 2531 can include data communication, voice communication, multimedia communication, short-range communications such as Bluetooth, near-field communication, location-based communication such as the use of the global positioning system (GPS) to determine a location, another like communication function, or any combination thereof. For example, communication subsystem 2531 can include cellular communication, Wi-Fi communication, Bluetooth communication, and GPS communication. Network 2543b can encompass wired and/or wireless networks such as a local-area network (LAN), a wide-area network (WAN), a computer network, a wireless network, a telecommunications network, another like network or any combination thereof. For example, network 2543b can be a cellular network, a Wi-Fi network, and/or a near-field network. Power source 2513 can be configured to provide alternating current (AC) or direct current (DC) power to components of UE 2500.

The features, benefits and/or functions described herein can be implemented in one of the components of UE 2500 or partitioned across multiple components of UE 2500. Further, the features, benefits, and/or functions described herein can be implemented in any combination of hardware, software or firmware. In one example, communication subsystem 2531 can be configured to include any of the components described herein. Further, processing circuitry 2501 can be configured to communicate with any of such components over bus 2502. In another example, any of such components can be represented by program instructions stored in memory that when executed by processing circuitry 2501 perform the corresponding functions described herein. In another example, the functionality of any of such components can be partitioned between processing circuitry 2501 and communication subsystem 2531. In another example, the non-computationally intensive functions of any of such components can be implemented in software or firmware and the computationally intensive functions can be implemented in hardware.

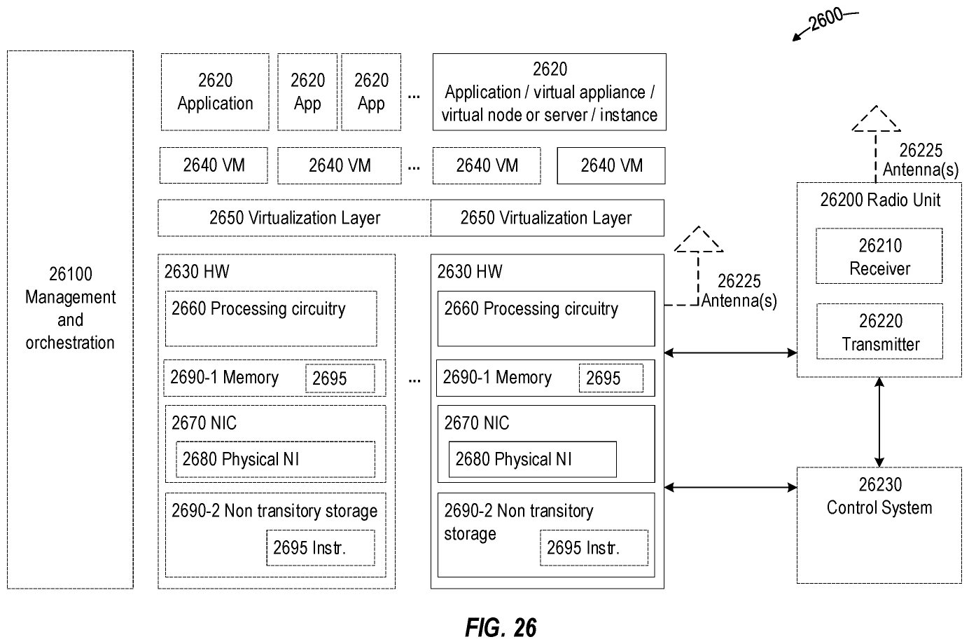

FIG. 26 is a schematic block diagram illustrating a virtualization environment 2600 in which functions implemented by some embodiments can be virtualized. In the present context, virtualizing means creating virtual versions of apparatuses or devices which can include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein can be implemented as virtual components executed by one or more virtual machines implemented in one or more virtual environments 2600 hosted by one or more of hardware nodes 2630. Further, in embodiments in which the virtual node is not a radio access node or does not require radio connectivity (e.g., a core network node), then the network node can be entirely virtualized.

The functions can be implemented by one or more applications 2620 (which can alternatively be called software instances, virtual appliances, network functions, virtual nodes, virtual network functions, etc.) operative to implement some of the features, functions, and/or benefits of some of the embodiments disclosed herein. Applications 2620 are run in virtualization environment 2600 which provides hardware 2630 comprising processing circuitry 2660 and memory 2690. Memory 2690 contains instructions 2695 executable by processing circuitry 2660 whereby application 2620 is operative to provide one or more of the features, benefits, and/or functions disclosed herein.

Virtualization environment 2600, comprises general-purpose or special-purpose network hardware devices 2630 comprising a set of one or more processors or processing circuitry 2660, which can be commercial off-the-shelf (COTS) processors, dedicated Application Specific Integrated Circuits (ASICs), or any other type of processing circuitry including digital or analog hardware components or special purpose processors. Each hardware device can comprise memory 2690-1 which can be non-persistent memory for temporarily storing instructions 2695 or software executed by processing circuitry 2660. Each hardware device can comprise one or more network interface controllers (NICs) 2670, also known as network interface cards, which include physical network interface 2680. Each hardware device can also include non-transitory, persistent, machine-readable storage media 2690-2 having stored therein software 2695 and/or instructions executable by processing circuitry 2660. Software 2695 can include any type of software including software for instantiating one or more virtualization layers 2650 (also referred to as hypervisors), software to execute virtual machines 2640 as well as software allowing it to execute functions, features and/or benefits described in relation with some embodiments described herein.

Virtual machines 2640, comprise virtual processing, virtual memory, virtual networking or interface and virtual storage, and can be run by a corresponding virtualization layer 2650 or hypervisor. Different embodiments of the instance of virtual appliance 2620 can be implemented on one or more of virtual machines 2640, and the implementations can be made in different ways.

During operation, processing circuitry 2660 executes software 2695 to instantiate the hypervisor or virtualization layer 2650, which can sometimes be referred to as a virtual machine monitor (VMM). Virtualization layer 2650 can present a virtual operating platform that appears like networking hardware to virtual machine 2640.

As shown in FIG. 26, hardware 2630 can be a standalone network node with generic or specific components. Hardware 2630 can comprise antenna 26225 and can implement some functions via virtualization. Alternatively, hardware 2630 can be part of a larger cluster of hardware (e.g., such as in a data center or customer premise equipment (CPE)) where many hardware nodes work together and are managed via management and orchestration (MANO) 26100, which, among others, oversees lifecycle management of applications 2620.

Virtualization of the hardware is in some contexts referred to as network function virtualization (NFV). NFV can be used to consolidate many network equipment types onto industry standard high volume server hardware, physical switches, and physical storage, which can be located in data centers, and customer premise equipment.

In the context of NFV, virtual machine 2640 can be a software implementation of a physical machine that runs programs as if they were executing on a physical, non-virtualized machine. Each of virtual machines 2640, and that part of hardware 2630 that executes that virtual machine, be it hardware dedicated to that virtual machine and/or hardware shared by that virtual machine with others of the virtual machines 2640, forms a separate virtual network elements (VNE).

Still in the context of NFV, Virtual Network Function (VNF) is responsible for handling specific network functions that run in one or more virtual machines 2640 on top of hardware networking infrastructure 2630 and corresponds to application 2620 in FIG. 26.

In some embodiments, one or more radio units 26200 that each include one or more transmitters 26220 and one or more receivers 26210 can be coupled to one or more antennas 26225. Radio units 26200 can communicate directly with hardware nodes 2630 via one or more appropriate network interfaces and can be used in combination with the virtual components to provide a virtual node with radio capabilities, such as a radio access node or a base station.

In some embodiments, some signalling can be effected with the use of control system 26230 which can alternatively be used for communication between the hardware nodes 2630 and radio units 26200.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, displaying functions, etc., such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification, drawings and exemplary embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the present disclosure include, but are not limited to, the following enumerated examples.
1. A method performed by a centralized unit (CU) in a radio access network (RAN) comprising a first RAN node and a plurality of further RAN nodes, the method comprising:
   Determining that a control plane (CP) connection between the first RAN node and the CU should be moved from a source path to a target path, wherein:
      The source path comprises a first subset of the further RAN nodes and a source distributed unit (DU) connected to the CU; and
      The target path comprises a second subset of the further RAN nodes and a target DU connected to the CU; and
   Sending, to the first RAN node via the source path, a message comprising a transport network layer (TNL) association related to the target DU.
2. The method of embodiment 1, further comprising:
   receiving, from the first node via the target DU, a setup request for a transport layer protocol connection related to the CP connection;
   establishing the requested transport layer protocol connection; and
   associating the established transport layer protocol connection with the TNL association related to the target DU.
3. The method of embodiment 2, further comprising sending, to the first node via the target DU, a confirmation that the CP connection has been moved to the target path.
4. The method of embodiment 3, further comprising:
   receiving one or control messages from the first node via the target path;
   determining if the one of more control messages were previously received from the first node via the source path; and
   if it is determined that the one of more control messages were previously received via the source path, discarding the one or more control messages received via the target path.
5. The method of any of embodiments 1-4, wherein the RAN is an integrated access backhaul network (IAB).
6. The method of any of embodiments 1-5, wherein the transport layer protocol is Stream Control Transmission Protocol (SCTP).
7. The method of any of embodiments 1-6, wherein the first node comprises a first CU and a first DU, and the CP connection is an F1-C connection between the CU and the first DU.
8. A method performed by a first node in a radio access network (RAN) comprising a centralized unit (CU) and a plurality of further RAN nodes, the method comprising:
   receiving, via a control plane (CP) connection with the CU via a source path, a message comprising a transport network layer (TNL) association related to a target path, wherein:
      The source path comprises a first subset of the further RAN nodes and a source distributed unit (DU) connected to the CU; and
      The target path comprises a second subset of the further RAN nodes and a target DU connected to the CU; and
   Establishing a network-layer connection to the target DU based on the TNL association; and
   Establishing, with the CU via the target DU, a transport layer protocol connection related to the CP connection.
9. The method of embodiment 8, wherein the transport layer protocol connection is associated with the TNL association.
10. The method of embodiment 9, further comprising receiving, from the CU via the target DU, a confirmation that the CP connection has been moved to the target path.
11. The method of embodiment 10, further comprising sending one or control messages to the CU via the target path, wherein the one or more control messages were previously sent to the CU via the source path.
12. The method of any of embodiments 8-11, wherein the RAN is an integrated access backhaul network (IAB).
13. The method of any of embodiments 8-12, wherein the transport layer protocol is Stream Control Transmission Protocol (SCTP).
14. The method of any of embodiments 8-13, wherein the first node comprises a first CU and a first DU, and the CP connection is an F1-C connection between the CU and the first DU.
15. A centralized unit (CU) in a radio access network (RAN) comprising a first RAN node and a plurality of further RAN nodes, the CU comprising:
   A communication transceiver;
   processing circuitry operatively coupled to the communication transceiver and configured to perform operations corresponding to any of the methods of embodiments 1-7; and
   power supply circuitry configured to supply power to the CU.
16. A first node in a radio access network (RAN) comprising a centralized unit (CU) and a plurality of further RAN nodes, the first node comprising:
   A communication transceiver;
   processing circuitry operatively coupled to the communication transceiver and configured to perform operations corresponding to any of the methods of embodiments 8-14; and
   power supply circuitry configured to supply power to the first node.

1.-33. (canceled)

34. A method performed by a centralized unit (CU) in a radio access network (RAN) that includes a first radio access node and a plurality of further radio access nodes, the method comprising:
determining that a control plane (CP) connection between the CU and the first radio access node should be moved from a source path in the RAN to a target path in the RAN, wherein the target path includes at least one radio access node not included in the source path;
based on determining that the CP connection between the CU and the first radio access node should be moved, sending, to the first radio access node, a message including one or more transport network layer (TNL) associations related to the CP connection, wherein the message is sent before the first radio access node has relocated to the target path; and
after the first radio access node has relocated to the target path, establishing a transport layer protocol connection with the first radio access node over the target path based on the TNL associations.

35. The method of claim 34, wherein the one or more TNL associations include the following:
one or more first TNL associations, related to the source path, to be removed; and
one or more second TNL associations, related to the target path, to be added.

36. The method of claim 35, wherein the message also indicates that the second TNL associations are related to a relocation of the first radio access node from the source path to the target path.

37. The method of claim 35, wherein establishing the transport layer protocol connection with the first radio access node over the target path comprises receiving, from the first radio access node, an acknowledgement message indicating whether network-layer connections were successfully established for each of the second TNL associations.

38. The method of claim 35, wherein establishing the transport layer protocol connection with the first radio access node over the target path comprises:
receiving, from the first radio access node via one of the second TNL associations, a setup request for the transport layer protocol connection, wherein the setup request is received after the first radio access node has relocated to the target path;
associating the requested transport layer protocol connection with the CP connection; and
sending, to the first radio access node, a response indicating that the requested transport layer protocol connection has been established in association with the CP connection.

39. The method of claim 35, wherein establishing a transport layer protocol connection with the first radio access node over the target path further comprises:
sending, to the first radio access node via one of the second TNL associations, a setup request for the transport layer protocol connection, wherein the setup request is sent after the first radio access node has relocated to the target path; and
receiving, from the first radio access node, a response indicating that the requested transport layer protocol connection has been established in association with the CP connection.

40. The method of claim 35, wherein determining that the CP connection between the CU and the first radio access node should be moved is based on one or more of the following:
a measurement report, from the first radio access node, indicating that relocation to the target path is needed;
an indication, from a target distributed unit (DU) connected to the CU and included in the target path, that the first radio access node will be relocated to the target path; and
a message, from the target DU, including the first TNL associations to be removed and the second TNL associations to be added.

41. The method of claim 34, further comprising:
receiving one or more control messages from the first radio access node via the CP connection over the target path;
determining if the one of more control messages were previously received from the first radio access node via the CP connection over the source path; and
if it is determined that the one of more control messages were previously received via the CP connection over the source path, discarding the one or more control messages received via the CP connection over the target path.

42. The method of claim 34, wherein:
the transport layer protocol connection is a Stream Control Transmission Protocol (SCTP) association; and
each TNL association includes a tunnel endpoint identifier (TEID) and an Internet Protocol (IP) address.

43. The method of claim 34, wherein:
the RAN is an integrated access backhaul (IAB) network;
the first radio access node includes a first mobile terminal and a first distributed unit (DU); and
the CP connection is an F1-C connection between the CU and the first DU.

44. A method performed by a first radio access node in a radio access network (RAN) that includes a centralized unit (CU) and a plurality of further radio access nodes, the method comprising:
receiving via a control plane (CP) connection with the CU, a message including one or more transport network layer (TNL) associations related to the CP connection, wherein the message is received via a source path in the RAN;
subsequently relocating to a target path in the RAN, wherein the target path includes at least one radio access node not included in the source path; and
after relocating to the target path in the RAN, establishing a transport layer protocol connection with the CU over the target path based on the received TNL associations.

45. The method of claim 44, wherein the one or more TNL associations include the following:
one or more first TNL associations, related to the source path, to be removed; and
one or more second TNL associations, related to the target path, to be added.

46. The method of claim 45, wherein the message also indicates that the second TNL associations are related to a relocation of the first radio access node from the source path to the target path.

47. The method of claim 44, wherein:
the source path includes a first subset of the further radio access nodes and a source distributed unit (DU) connected to the CU; and
the target path includes a second subset of the further radio access nodes and a target DU connected to the CU.

48. The method of claim 47, wherein establishing the transport layer protocol connection with the CU over the target path comprises:
establishing one or more network-layer connections to the target DU based on the respective one or more second TNL associations; and
establishing the transport layer protocol connection with the CU, via the target DU, based on at least one of the established network-layer connections.

49. The method of claim 48, wherein establishing the transport layer protocol connection with the CU over the target path further comprises sending, to the CU, an acknowledgement message indicating whether network-layer connections were successfully established for each of the second TNL associations.

50. The method of claim 48, wherein establishing the transport layer protocol connection based on at least one of the established network-layer connections further comprises:
sending, to the CU via one of the second TNL associations, a setup request for the transport layer protocol connection; and
receiving, from the CU, a response indicating that the requested transport layer protocol connection has been established in association with the CP connection.

51. The method of claim 50, wherein the response includes an identifier associated with the CP connection over the source path.

52. The method of claim 48, wherein establishing the transport layer protocol connection based on at least one of the established network-layer connections further comprises:
receiving, from the CU via one of the second TNL associations, a setup request for the transport layer protocol connection;
associating the requested transport layer protocol connection with the CP connection; and
sending, to the CU, a response indicating that the requested transport layer protocol connection has been established in association with the CP connection.

53. The method of claim 44, further comprising sending one or control messages to the CU via the CP connection over the target path, wherein the one or more control messages were previously sent to the CU via the CP connection over the source path.
